(19) United States
(12) Patent Application Publication
(10) Pub. No.: US 2018/0024656 A1
(43) Pub. Date: Jan. 25, 2018

(54) METHOD AND APPARATUS FOR OPERATION OF AN ELECTRONIC DEVICE

(71) Applicant: Samsung Electronics Co., Ltd., Gyeonggi-do (KR)

(72) Inventors: Sangheon KIM, Gyeongsangbuk-do (KR); ln-Hyung JUNG, Gyeongsangbuk-do (KR); Jong-Wu BAEK, Gyeongsangbuk-do (KR); Geon-Soo KIM, Gyeonggi-do (KR); Yohan LEE, Gyeonggi-do (KR)

(73) Assignee: Samsung Electronics Co., Ltd.

(21) Appl. No.: 15/412,634

(22) Filed: Jan. 23, 2017

(30) Foreign Application Priority Data
Jul. 20, 2016 (KR) 10-2016-0092098

(51) Int. Cl. G06F 3/0354; G06F 3/0484; G06F 3/0481; G06F 3/044; G06F 3/041

(52) U.S. Cl. CPC G06F 3/03545; G06F 3/044; G06F 3/0416; G06F 3/04817; G06F 3/04845; G06F 2203/04105

(57) ABSTRACT

Disclosed is a method and apparatus for controlling an electronic device by using a force input of the electronic device. The method includes displaying a screen comprising at least one object on a touch screen display, receiving data indicating that an external object is pressed on the touch screen display by a force greater than or equal to a selected force, receiving a manual input through the touch screen display after the data is received, displaying at least one of an image and a character on the touch screen display in a manner overlapping with the screen based on the manual input, and deleting the at least one of the image and the character while directly maintaining the screen when a selected time has elapsed.

### PRIORITY

This application claims priority under 35 U.S.C. §119(a) to a Korean Patent Application filed in the Korean Intellectual Property Office on Jul. 20, 2016 and assigned Serial No. 10-2016-0092098, the contents of which are incorporated herein by reference.

### BACKGROUND

### 1. Field of the Disclosure

The present disclosure relates generally to a method and apparatus for operating an electronic device, and more particularly, to a method and apparatus for controlling the electronic device by using a force input in the electronic device.

### 2. Description of the Related Art

With the recent advances in electronic technologies, an electronic device has increased complex functions. For example, the electronic device can provide a user with scheduling, photographing, and web searching functions through an application. Accordingly, most electronic devices currently employ a touch screen capable of increasing a size of a display of the electronic device to provide the user with an abundance of information.

The electronic device may input and output the information through the touch screen, such as by detecting a touch input of the user through the touch screen, and may perform a function corresponding to the detected touch input.

The electronic device can provide a user with various functions by performing a control instruction corresponding to a user input detected through a touch screen. For example, the electronic device can store information generated based on the user input detected through the touch screen, and can provide the user with the stored information.

In the process, however, the conventional electronic device inconveniently executes an application having the information stored therein. For example, the electronic device provides the user with the stored information to confirm information stored in a memo application during execution of a web search application, and thereafter, inconveniently returns to the web search application. Although a multi-window function for displaying multiple applications is now provided, the conventional electronic device inconveniently decreases the readability of information when operating in the multi-window function.

As such, there is a need in the art for a method and an electronic device that prevent limitations in the readability of information in the multi-window function.

### SUMMARY

Accordingly, the present disclosure is made to address at least the disadvantages described above and to provide at least the advantages described below.

An aspect of the present disclosure is to provide a method and apparatus for controlling an electronic device by using a force input in the electronic device.

In accordance with an aspect of the present disclosure, an electronic device may include a housing including a first surface directed in a first direction and a second surface directed in a second direction opposite to the first direction, a touch screen display located between the first surface and the second surface and exposed through the first surface, a force sensor located between the first surface and the second surface and detecting a force caused by an external object as to the touch screen display, a wireless communication circuit, at least one processor electrically connected to the touch screen display, the force sensor, and the wireless communication circuit, and a memory electrically connected to the processor, wherein the memory comprises instructions, when executed, cause the processor to display a screen including at least one object on the touch screen display, receive data indicating that the external object is pressed on the touch screen display by a force greater than or equal to a selected force from at least one of the force sensor and the wireless communication circuit, receive a manual input through the touch screen display after the data is received, display at least one of an image and a character on the touch screen display in a manner overlapping with the screen, based on the manual input, and delete the at least one of the image and the character while directly maintaining the screen when a selected time has elapsed.

In accordance with another aspect of the present disclosure, an electronic device may include a housing including a first surface directed in a first direction and a second surface directed in a second direction opposite to the first direction, a touch screen display located between the first surface and the second surface and exposed through the first surface, a wireless communication circuit, at least one processor electrically connected to the touch screen display and the wireless communication circuit, and a memory electrically connected to the at least one processor, wherein the memory may include instructions, when executed, cause the processor to display a screen including at least one object on the touch screen display, receive data indicating that the external object is pressed on the touch screen display by a force greater than or equal to a selected force from an external object through the wireless communication circuit, receive a manual input through the touch screen display after the data is received, display at least one of an image and a character on the touch screen display in a manner overlapping with the screen based on the manual input, and delete the at least one of the image and the character while directly maintaining the screen when a selected time has elapsed.

In accordance with another aspect of the present disclosure, an electronic device may include a housing including a first surface directed in a first direction and a second surface directed in a second direction opposite to the first direction, a touch screen display located between the first surface and the second surface, exposed through the first surface, and including a first panel for displaying at least one object and a second panel for detecting a touch input, a force sensor located between the first surface and the second surface and detecting a force caused by an external object as to the touch screen display, a wireless communication circuit, at least one processor electrically connected to the touch screen display, the force sensor, and the wireless communication circuit, and a memory electrically connected to the processor, wherein the memory comprises instructions, when executed, cause the processor to receive data indicating that the external object is pressed on the touch screen display by a force greater than or equal to a selected force, when the first panel is off, from at least one of the force sensor and the wireless communication circuit, receive a manual input through the second panel after the data is received, display at least one of an image and a character based on the manual input by using the first panel, and delete the display of the at least one of the image and the character on the first panel when a selected time has elapsed.

In accordance with another aspect of the present disclosure, an electronic device may include a housing including a first surface directed in a first direction and a second surface directed in a second direction opposite to the first direction, a touch screen display located between the first surface and the second surface, exposed through the first surface, and including a first penal for displaying at least one object and a second panel for detecting a touch input, a wireless communication circuit, at least one processor electrically connected to the touch screen display and the wireless communication circuit, and a memory electrically connected to the at least one processor, wherein the memory comprises instructions, when executed, cause the processor to receive data indicating that the external object is pressed on the touch screen display by a force greater than or equal to a selected force, when the first panel is off, from the wireless communication circuit, display at least one of at least one of an image and a character based on the manual input by using the first panel, and delete the display the at least one of the image and the character on the first panel when a selected time has elapsed.

In accordance with another aspect of the present disclosure, a method of operating an electronic device may include displaying a screen including at least one object on a touch screen display of the electronic device, receiving data indicating that the external object is pressed on the touch screen display by a force greater than or equal to a selected force from at least one of a force sensor of the electronic device and a wireless communication circuit of the electronic device, receiving a manual input through the touch screen display after the data is received, displaying at least one of an image and a character on the touch screen display in a manner overlapping with the screen based on the manual input, and deleting the at least one of the image and the character while directly maintaining the screen when a selected time has elapsed.

In accordance with another aspect of the present disclosure, a method of operating an electronic device may include displaying a screen including at least one object on a touch screen display of the electronic device, receiving data indicating that the external object is pressed on the touch screen display by a force greater than or equal to a selected force from an external object through a wireless communication circuit of the electronic device, receiving a manual input through the touch screen display after the data is received, displaying at least one of an image and a character on the touch screen display in a manner overlapping with the screen based on the manual input, and deleting the at least one of the image and the character while directly maintaining the screen when a selected time has elapsed.

In accordance with another aspect of the present disclosure, a method of operating an electronic device may include receiving data indicating that the external object is pressed on the touch screen display by a force greater than or equal to a selected force from at least one of a force sensor of the electronic device and a wireless communication circuit of the electronic device when a first panel of a touch screen display of the electronic device is off, receiving a manual input through a second panel of the touch screen display after the data is received, displaying at least one of an image and a character based on the manual input by using the first panel, and deleting the display of the at least one of the image and the character on the first panel when a selected time has elapsed.

In accordance with another aspect of the present disclosure, a method of operating an electronic device may include receiving data indicating that the external object is pressed on the touch screen display by a force greater than or equal to a selected force from a wireless communication circuit of the electronic device when a first panel of a touch screen display of the electronic device is off, displaying at least one of an image and a character based on the manual input by using the first panel, and deleting the display of at least one of the image and the character on the first panel when a selected time has elapsed.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates an electronic device in a network environment according to embodiments of the present disclosure;

FIG. 2 illustrates a block diagram of an electronic device according to embodiments of the present disclosure;

FIG. 3 illustrates a block diagram of a program module according to embodiments of the present disclosure;

FIG. 4 is a cross-sectional view of an electronic device according to embodiments of the present disclosure;

FIG. 5A and FIG. 5B illustrate a block diagram of an electronic device according to embodiments of the present disclosure;

FIG. 6 illustrates a block diagram of an electronic device and a pen according to embodiments of the present disclosure;

FIG. 7 illustrates a method for controlling an electronic device by using a force input in the electronic device according to embodiments of the present disclosure;

FIG. 8 illustrates a method for detecting a force input in an electronic device according to embodiments of the present disclosure;

FIG. 9 illustrates an example of determining an input force in an electronic device according to embodiments of the present disclosure;

FIG. 10 illustrates a method for displaying information generated based on a user input on a layer displayed on a touch screen in an electronic device according to embodiments of the present disclosure;

FIG. 11 illustrates a configuration of a layer based on a force input in an electronic device according to embodiments of the present disclosure;

FIG. 12A and FIG. 12B illustrate an example of controlling a layer on which a stroke is displayed based on a user input in an electronic device according to embodiments of the present disclosure;

FIG. 13A and FIG. 13B illustrate an example of performing a telephone function by using a force input in an electronic device according to embodiments of the present disclosure;

FIG. 14 illustrates an example of performing a memo function by using a force input in an electronic device according to embodiments of the present disclosure;

FIG. 15 illustrates an example of displaying information marked based on a force input in another electronic device according to embodiments of the present disclosure;

FIG. 16 illustrates a method of controlling an electronic device by using a force input based on state information of the electronic device in the electronic device according to embodiments of the present disclosure;

FIG. 17 illustrates an example of performing a memo function related to content based on a force input of an electronic device according to embodiments of the present disclosure;

FIG. 18 illustrates an example of displaying information generated based on a force input in an electronic device according to embodiments of the present disclosure;

FIG. 19 illustrates a method of displaying notification information based on a force input in an electronic device according to embodiments of the present disclosure;

FIG. 20 illustrates an example of displaying notification information based on a force input in an electronic device according to embodiments of the present disclosure;

FIG. 21 illustrates a method of broadcasting information generated based on a force input in an electronic device according to embodiments of the present disclosure;

FIG. 22 illustrates an example of broadcasting information generated based on a force input in an electronic device according to embodiments of the present disclosure; and

FIG. 23 illustrates a range of broadcasting information generated based on a force input in an electronic device according to embodiments of the present disclosure.

### DETAILED DESCRIPTION OF EMBODIMENTS OF THE DISCLOSURE

Hereinafter, embodiments of the present disclosure are described with reference to the accompanying drawings. It should be understood, however, that the present disclosure is not intended to be limited to the embodiments of the particular forms disclosed, but, on the contrary, is intended to cover all modifications, equivalents, and alternatives falling within the spirit and scope of the embodiments of the present disclosure. A description of well-known functions and/or configurations will be omitted for the sake of clarity and conciseness.

Like reference numerals denote like components throughout the drawings. A singular expression includes a plural concept unless there is a contextually distinctive difference therebetween. In the present disclosure, an expression “A or B” or “A and/or B” may include all possible combinations of items enumerated together. Although expressions such as “1^{st}”, “2^{nd}”, “first”, and “second” may be used to express corresponding constituent elements, the use of these expressions is not intended to limit the corresponding constituent elements. When a 1^{st} constituent element is mentioned as being “operatively or communicatively coupled with/to” or “connected to” a different (e.g., 2^{nd}) constituent element, the 1st constituent element is directly coupled with/to the 2^{nd} constituent element or can be coupled with/to the 2^{nd} constituent element via another (e.g., 3^{rd}) constituent element.

An expression “configured to” used in the present disclosure may, for example, be interchangeably used with “suitable for”, “having the capacity to”, “adapted to”, “made to”, “capable of”, or “designed to” in a hardware or software manner according to a situation. In a certain situation, an expression “a device configured to” may imply that the device is “capable of” operating together with other devices or components. For example, “a processor configured to perform A, B, and C” may imply an embedded processor for performing a corresponding operation or a generic-purpose processor (e.g., central processing unit (CPU) or an application processor) capable of performing corresponding operations by executing one or more software programs stored in a memory device.

An electronic device according to embodiments of the present disclosure may include at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), a motion pictures experts group (MPEG)-1 audio layer 3 (MP3) player, a mobile medical device, a camera, and a wearable device.

The wearable device may include at least one of an accessory-type device, such as a watch, a ring, a bracelet, an anklet, a necklace, glasses, contact lenses, or a head-mounted device (HMD), a fabric- or clothes-integrated device such as electronic clothes, a body attaching-type device such as a skin pad or tattoo, or a body implantable device such as an implantable circuit. According to certain embodiments, the electronic device may include at least one of a television (TV), a digital video disk (DVD) player, an audio player, a refrigerator, an air conditioner, a cleaner, an oven, a microwave oven, a washing machine, an air purifier, a set-top box, a home automation control panel, a security control panel, a TV box (e.g., Samsung HomeSync™, Apple TV™, or Google TV™), a game console (e.g., Xbox™, PlayStation™), an electronic dictionary, an electronic key, a camcorder, and an electronic picture frame.

According to other embodiments, the electronic device may include at least one of various portable medical measuring devices such as a blood sugar measuring device, a heart rate measuring device, a blood pressure measuring device, or a body temperature measuring device, magnetic resonance angiography (MRA), magnetic resonance imaging (MRI), computed tomography (CT), imaging equipment, ultrasonic instrument, a navigation device, a global positioning system (GPS) receiver, an event data recorder (EDR), a flight data recorder (FDR), a car infotainment device, an electronic equipment for ship, such as a vessel navigation device or a gyro compass, avionics, a security device, a car head unit, an industrial or domestic robot, a drone, an automated teller machine (ATM), point of sales (POS) device, and Internet of things devices, such as a light bulb, various sensors, an electric or gas meter, a sprinkler device, a fire alarm, a thermostat, a streetlamp, a toaster, a fitness equipment, a hot water tank, a heater, or a boiler.

According to certain embodiments, the electronic device may include at least one of one part of furniture, buildings/constructions or cars, an electronic board, an electronic signature receiving device, a projector, and various measurement machines such as a water supply, electricity, gas, or propagation measurement machine. The electronic device according to embodiments may be flexible, or may be a combination of two or more of the aforementioned various devices. The electronic device is not limited to the aforementioned devices. The term ‘user’ used in the present disclosure may refer to a person who uses the electronic device or an artificial intelligence (AI) electronic device which uses the electronic device.

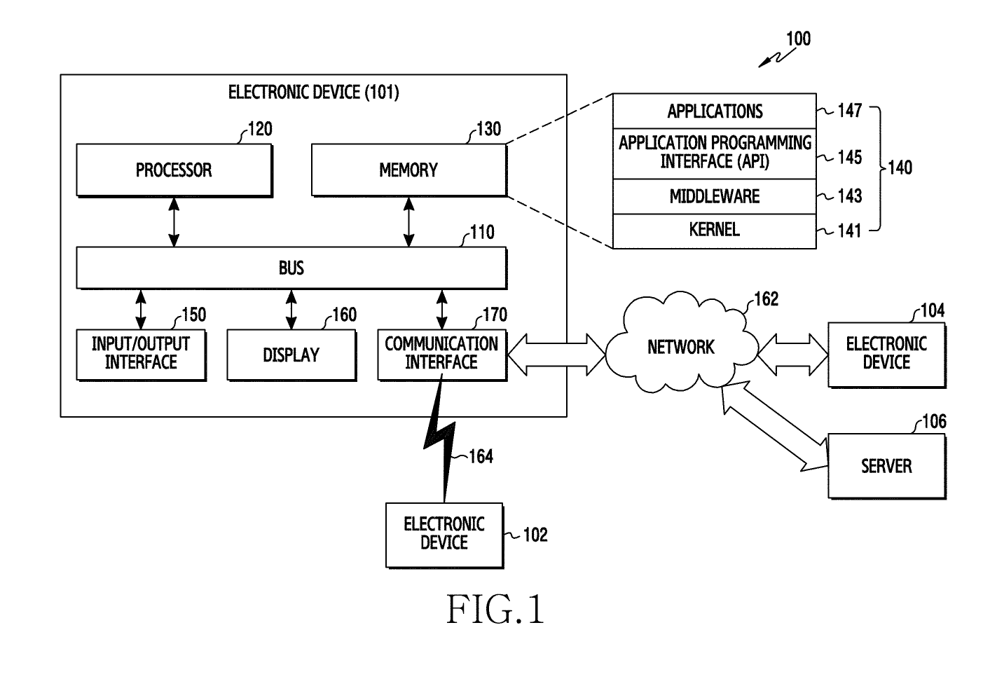

FIG. 1 illustrates an electronic device 101 in a network environment 100 according to embodiments of the present disclosure.

Referring to FIG. 1, the electronic device 101 may include a bus 110, a processor 120, a memory 130, an input/output interface 150, a display 160, and a communication interface 170. In a certain embodiment, the electronic device 101 may omit at least one of the aforementioned constituent elements or may additionally include other constituent elements. The bus 110 may include a circuit for connecting the aforementioned constituent elements 120 to 170 to each other and for delivering a control message and/or data between the aforementioned constituent elements.

The processor 120 may include one or more of a central processing unit (CPU), an application processor (AP), and a communication processor (CP). The processor 120 may control at least one of other constituent elements of the electronic device 101 and/or may execute an arithmetic operation or data processing for communication.

The processor 120 may determine whether the user input detected through the display 160 (e.g., the touch screen) or received through the communication interface 170 is a force input. For example, the processor 120 may detect the user input through the display 160 and determine whether a movement amount of the user input is less than or equal to a pre-set first threshold in response to the detection of the user input. If the movement amount of the user input is less than or equal to the pre-set first threshold, the processor 120 may determine whether a force caused by the user input for the display 160 is greater than or equal to a pre-set second threshold. If the force is greater than or equal to the pre-set second threshold, the processor 120 may determine whether the user input is moved instead of being released. If the user input is moved instead of being released, the processor 120 may determine the user input as the force input.

The processor 120 may confirm the force caused by the user input for the display 160 through a force sensor included in the display 160. Alternatively, the processor 120 may receive force information caused by the user input for the display 160 through the communication interface 170. For example, the processor 120 may receive the force information caused by an external electronic device for the display 160 from the external electronic device 102 or 104 connected through the communication interface 170. Herein, the external electronic device may include a stylus pen.

The processor 120 may generate a layer of which a maintaining time is set based on the force confirmed through the force sensor included in the display 160. For example, if a magnitude of the force confirmed through the force sensor included in the display 160 is of a first level, the processor 120 may generate a layer which is set to be maintained for a first hour. Alternatively, if the magnitude of the force confirmed through the display 160 is of a second level, the processor 120 may generate a layer which is set to be maintained for a second hour. Herein, the first level may indicate a force level higher than the second level, and the first time may be longer than the second time.

The processor 120 may display information generated based on the user input on the generated layer. For example, if the user input is the force input, the processor 120 may load a recognition engine from the memory 130 to recognize the user input, may store into the memory 130 a stroke generated based on the user input which is input through the display 160 by using the recognition engine, may display the stroke generated based on the user input on the generated layer, and may determine whether the force input ends through a user interface (e.g., an end button) displayed on the generated layer.

If the maintaining time set to the layer elapses, the processor 120 may delete the layer displayed on the display 160. For example, if one minute elapses from a time point at which the information generated based on the user input is displayed on the layer set to be maintained for one minute, the processor 120 may delete the layer. Alternatively, if one minute elapses from the time point at which the information generated based on the user input is displayed on the layer set to be maintained for one minute, the processor 120 may output a screen for inquiring whether to delete the layer and may delete the layer based on the user input.

If the maintaining time set to the generated layer has not elapsed, the processor 120 may continuously display the generated layer on the display 160. For example, if a user input for changing to a home screen is received when the maintaining time set to the generated layer has not elapsed, the processor 120 may continuously display the generated layer on a layer of the home screen. Alternatively, if a user input for changing to a text message application is received when the maintaining time set to the generated layer has not elapsed, the processor 120 may continuously display the generated layer on a layer of the text message application. Alternatively, if an input for turning off the displaying of the display 160 is received when the maintaining time set to the generated layer has not elapsed, the processor 120 may maintain the displaying of the generated layer and may turn off the displaying of the remaining regions.

The processor 120 may transmit the generated layer to the external electronic device through the communication interface 170 (e.g., the wireless communication circuit). For example, the processor 120 may confirm the external electronic device connected through the communication interface 170 and may request and receive information for determining whether to display the generated layer from the confirmed external electronic device. If the external electronic device is capable of displaying the generated layer, the processor 120 may transmit the generated layer to the external electronic device through the communication interface 170.

The memory 130 may include a volatile and/or non-volatile memory. The memory 130 may store an instruction or data related to at least one different constituent element of the electronic device 101 and may store a software and/or a program 140. The program 140 may include a kernel 141, a middleware 143, an application programming interface (API) 145, and application programs (i.e., “applications”) 147. At least one part of the kernel 141, middleware 143, or API 145 may be referred to as an operating system (OS). The kernel 141 may control or manage system resources used to execute an operation or function implemented in other programs, and may provide an interface capable of controlling or managing the system resources by accessing individual constituent elements of the electronic device 101 in the middleware 143, the API 145, or the applications 147. The memory 130 may store and load the recognition engine for detecting the persistent (i.e., continuous) user input. The memory 130 may store the recognition engine for recognizing the stroke based on the user input detected through the display 160.

The middleware 143 may perform a mediation role so that the API 145 or the applications 147 can communicate with the kernel 141 to exchange data. Further, the middleware 143 may handle one or more task requests received from the applications 147 according to a priority. For example, the middleware 143 may assign a priority capable of using the system resources of the electronic device 101 to at least one of the application programs 147, and may handle the one or more task requests. The API 145 may include at least one interface or function for file control, window control, video processing, or character control, as an interface capable of controlling a function provided by the applications 147 in the kernel 141 or the middleware 143. The input/output interface 150 may deliver an instruction or data input from a user or a different external device(s) to the different constituent elements of the electronic device 101, or may output an instruction or data received from the different constituent element(s) of the electronic device 101 to the different external device.

The display 160 may include various types of displays, such as a liquid crystal display (LCD), a light emitting diode (LED) display, an organic light-emitting diode (OLED) display, a microelectromechanical Systems (MEMS) display, or an electronic paper display. The display 160 may display, to the user, a variety of contents such as text, image, video, icons, and symbols. The display 160 may include a touch screen that may receive a touch, gesture, proximity, or hovering input by using a stylus pen or a part of a user's body. For example, the display 160 may include a first panel for detecting an input using the part of the user's body and a second panel for receiving an input using the stylus pen. The display 160 may perform an always on display (AOD) function for detecting a user input when a display function is off. The display 160 may include a force sensor for detecting a force caused by an external object for the display, and may perform an always on force (AOF) function for detecting a force caused by the user input when the display function of the display is off Herein, the external object may include the part of the user's body or the stylus pen.

The communication interface 170 may establish communication between the electronic device 101 and the external device (e.g., a 1^{st} external electronic device 102, a 2^{nd} external electronic device 104, or a server 106). For example, the communication interface 170 may communicate with the 2^{nd} external electronic device 104 or the server 106 by being connected with a network 162 through wireless communication or wired communication.

The wireless communication may include cellular communication using at least one of long term evolution (LTE), LTE Advanced (LTE-A), code division multiple access (CDMA), wideband CDMA (WCDMA), universal mobile telecommunications system (UMTS), wireless broadband (WiBro), and global system for mobile communications (GSM). The wireless communication may include at least one of wireless fidelity (WiFi), Bluetooth®, Bluetooth low energy (BLE), Zigbee®, near field communication (NFC), magnetic secure transmission, radio frequency (RF), and body area network (BAN).

The wireless communication may include a global navigation satellite system (GNSS) or (Glonass) such as Beidou navigation satellite system (hereinafter, “Beidou”) or Galileo, and the European global satellite-based navigation system. Hereinafter, “GPS” and “GNSS” may be interchangeably used. The wired communication may include at least one of universal serial bus (USB), high definition multimedia interface (HDMI), recommended standard-232 (RS-232), power-line communication, or plain old telephone service (POTS). The network 162 may include at least one of a telecommunications network, a computer network such as a local area network (LAN) or wide area network (WAN), the Internet, and a telephone network.

If the force caused by the stylus pen for the display 160 is greater than a pre-set second threshold, the communication interface 170 may receive information indicating that the force input is detected from the stylus pen. In this case, the stylus pen may include a force sensor for detecting the force input and a wireless communication circuit for communicating with the communication interface 170.

Each of the 1^{st} and 2^{nd} external electronic devices 102 and 104 may be the same type as or different type than the electronic device 101. All or some of operations executed by the electronic device 101 may be executed in a different one or a plurality of electronic devices. According to one embodiment, if the electronic device 101 needs to perform a certain function or service either automatically or at a request, the electronic device 101 may request at least a part of functions related thereto alternatively or additionally to a different electronic device instead of executing the function or the service autonomously. The different electronic device may execute the requested function or additional function, and may deliver a result thereof to the electronic device 101. For example, the electronic device 101 may provide the requested function or service either directly or by additionally processing the received result, for which a cloud computing, distributed computing, or client-server computing technique may be used.

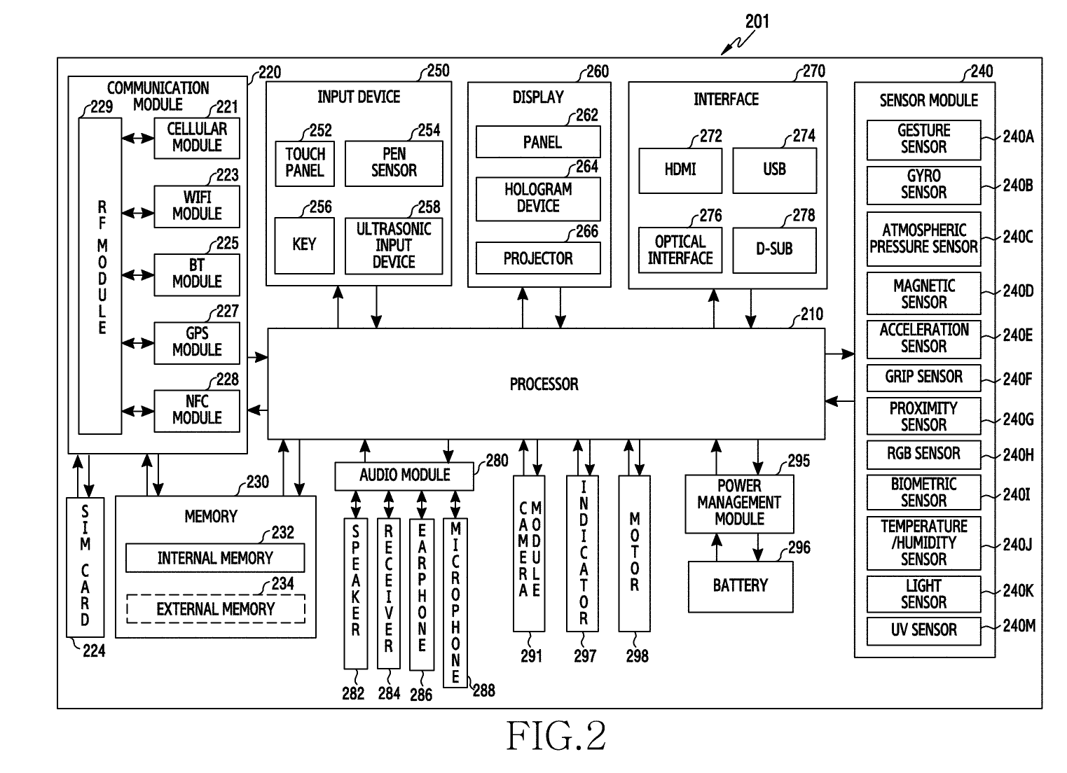

FIG. 2 illustrates a block diagram of an electronic device 201 according to embodiments of the present disclosure.

Referring to FIG. 2, the electronic device 201 may include all or some parts of the electronic device 101 of FIG. 1, and may include at least one application processor (AP) 210, a communication module 220, a subscriber identity module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software constituent elements connected to the processor 210 by driving an operating system or an application program, may process a variety of data including multimedia data and perform an arithmetic operation, and may be implemented with a system on chip (SoC). The processor 210 may further include a graphic processing unit (GPU) and/or an image signal processor. The processor 210 may include at least one part of the aforementioned constituent elements of FIG. 2. The processor 210 may process an instruction or data, which is received from at least one of different constituent elements (e.g., a non-volatile memory), by loading the instruction or data to a volatile memory and may store a variety of data in the non-volatile memory.

The communication module 220 may have the same or similar configuration of the communication interface 170. The communication module 220 may include the cellular module 221, a wife module 223, a Bluetooth (BT) module 225, a global positioning system (GPS) module 227, a near field communication (NFC) module 228, and an RF module 229. For example, the cellular module 221 may provide a voice call, a video call, a text service, or an Internet service through a communication network. The cellular module 221 may identify and authenticate the electronic device 201 in the communication network by using the SIM card 224, may perform at least some functions that can be provided by the processor 210, and may include a communication processor (CP). At least two of the cellular module 221, the WiFi module 223, the BT module 225, the GPS module 227, and the NFC module 228 may be included in one integrated chip (IC) or IC package. The RF module 229 may transmit/receive an RF signal and may include a transceiver, a power amp module (PAM), a frequency filter, a low noise amplifier (LNA), or an antenna. At least one of the cellular module 221, the WiFi module 223, the BT module 225, the GPS module 227, and the NFC module 228 may transmit/receive an RF signal via a separate RF module. The SIM card 224 may include a card including the SIM and/or an embedded SIM, and may include unique identification information such as an integrated circuit card identifier (ICCID) or subscriber information such as an international mobile subscriber identity (IMSI).

The memory 230 may include an internal memory 232 and/or an external memory 234. The internal memory 232 may include at least one of a volatile memory such as a dynamic random access memory (DRAM), a static RAM (SRAM), or a synchronous dynamic RAM (SDRAM), and a non-volatile memory such as a one-time programmable read-only memory (OTPROM), a programmable ROM (PROM), an erasable and programmable ROM (EPROM), an electrically erasable and programmable ROM (EEPROM), a mask ROM, a flash ROM, a flash memory such as a NAND or a NOR flash memory, a hard drive, or a solid state drive (SSD). The external memory 234 may further include a flash drive, such as a compact flash (CF), secure digital (SD), micro secure digital (Micro-SD), mini secure digital (Mini-SD), extreme Digital (xD), or a memory stick. The external memory 234 may be operatively and/or physically connected to the electronic device 201 via various interfaces.

The sensor module 240 may measure physical quantity or detect an operational status of the electronic device 201, and may convert the measured or detected information into an electric signal. The sensor module 240 may include at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H such as a red, green, blue (RGB) sensor, a biometric sensor 240I, a temperature/humidity sensor 240J, an illumination sensor 240K, and an ultra violet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling at least one sensor included therein. In a certain embodiment, the electronic device 201 may further include a processor configured to control the sensor module 204 either separately or as one part of the processor 210, and may control the sensor module 240 while the processor 210 is in a sleep state.

The input device 250 may include a touch panel 252, a (digital) pen sensor 254, a key 256, and an ultrasonic input device 258. The touch panel 252 may recognize a touch input by using at least one of an electrostatic type, a pressure-sensitive type, and an ultrasonic type, may further include a control circuit, as well as a tactile layer that provides the user with a tactile reaction. The (digital) pen sensor 254 may be one part of a touch panel, or may include an additional sheet for recognition. The key 256 may be a physical button, an optical key, a keypad, or a touch key. The ultrasonic input device 258 may detect an ultrasonic wave generated from an input means through a microphone 288 to confirm data corresponding to the detected ultrasonic wave.

The display 260 may include a panel 262, a hologram device 264, a projector 266, and/or a control circuit for controlling these elements. The panel 262 may be implemented in a flexible, transparent, or wearable manner and may be constructed as one module with the touch panel 252. According to one embodiment, the panel 262 may include a force sensor capable of measuring strength of a force of a user's touch. Herein, the force sensor may be implemented in an integral manner with respect to the panel 262, or with at least one separate sensor. The hologram 264 may use an interference of light and project a stereoscopic image in the air. The projector 266 may display an image by projecting a light beam onto a screen located inside or outside the electronic device 201. The interface 270 may include a high-definition multimedia interface (HDMI) 272, a universal serial bus (USB) 274, an optical communication interface 276, and a d-subminiature (D-sub) 278. The interface 270 may be included in the communication interface 170 of FIG. 1. Additionally or alternatively, the interface 270 may include a mobile high-definition link (MHL) interface, a secure digital (SD)/multi-media card (MMC) interface, or an infrared data association (IrDA) standard interface.

The audio module 280 may bilaterally convert a sound and electric signal. At least some constituent elements of the audio module 280 may be included in the input/output interface 150 of FIG. 1. The audio module 280 may convert sound information which is input or output through a speaker 282, a receiver 284, an earphone 286, or the microphone 288. The camera module 291 is a device for image and video capturing, and may include one or more image sensors, such as a front and/or a rear sensor, a lens, an image signal processor (ISP), or a flash, such as a light-emitting diode (LED) or xenon lamp.

The power management module 295 may manage power of the electronic device 201. According to one embodiment, the power management module 295 may include a power management integrated circuit (PMIC), a charger integrated circuit (IC), or a battery gauge. The PMIC may have a wired and/or wireless charging type. The wireless charging type may include a magnetic resonance, a magnetic induction, or an electromagnetic type, and may further include an additional circuit for wireless charging, such as a coil loop, a resonant circuit, or a rectifier. The battery gauge may measure residual quantity of the battery 296 and voltage, current, and temperature during charging. The battery 296 may include a rechargeable battery and/or a solar battery, for example.

The indicator 297 may indicate a specific state such as a booting, a message, or a charging state of the electronic device 201 or one component thereof. The motor 298 may convert an electric signal into a mechanical vibration, and may generate a vibration or haptic effect. The electronic device 201 may include a mobile TV supporting device (e.g., a GPU) capable of handling media data according to a protocol, such as digital multimedia broadcasting (DMB), digital video broadcasting (DVB), or media flow. Each of the constituent elements described in the present disclosure may consist of one or more components, and names thereof may vary depending on a type of the electronic device.

According to embodiments, some of the constituent elements of the electronic device 201 may be omitted, or additional constituent elements may be further included. Some of the constituent elements of the electronic device may be combined and constructed as one entity while performing the same functions of corresponding constituent elements as before they are combined.

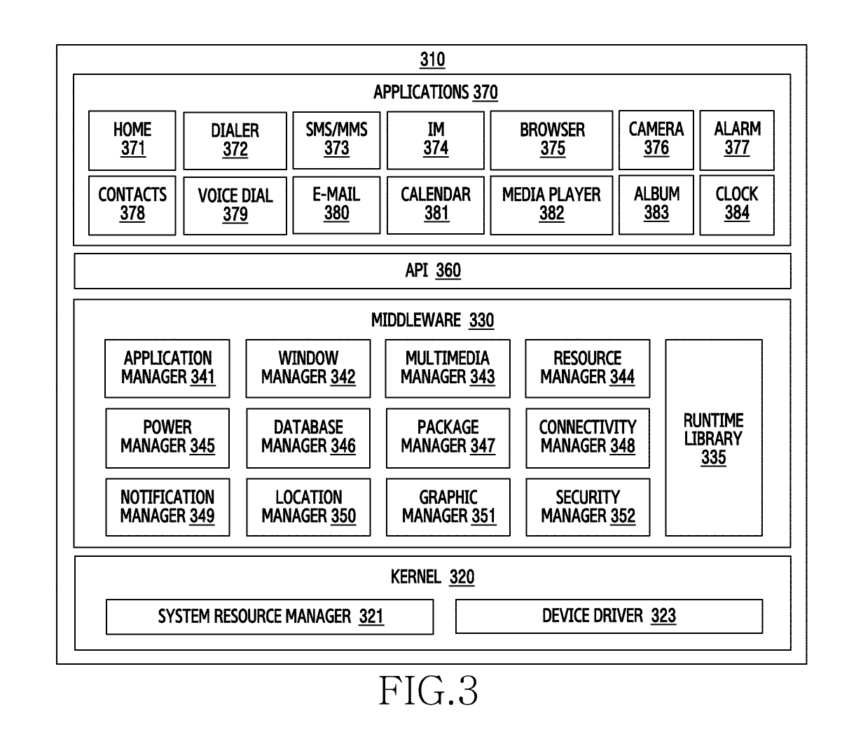

FIG. 3 is a block diagram of a program module according to embodiments of the present disclosure.

Referring to FIG. 3, the program module 310 may include an OS for controlling resources related to the electronic device and/or various applications executed in the OS. Examples of the OS may be Android®, iOS®, Windows®, Symbian®, Tizen®, or Bala®.

The program module 310 may include a kernel 320, middleware 330, an API 360, and/or applications 370. At least some of the program module 310 may be preloaded on an electronic device, or may be downloaded from an external electronic device.

The kernel 320 may include a system resource manager 321 and/or a device driver 323. The system resource manager 321 may control, allocate, or collect system resources and may include a process management unit, a memory management unit, and a file system management unit, for example. The device driver 323 may include a display, camera, Bluetooth®, shared memory, USB, keypad, Wi-Fi, audio, and inter-process communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while at least one of the applications 370 is being executed. The runtime library 335 may perform such functions as input/output management, memory management, and the functionality for an arithmetic function.

The application manager 341 may manage a life cycle of at least one of the applications 370. The window manager 342 may manage graphical user interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

For example, the power manager 345 may operate together with a basic input/output system (BIOS) to manage a battery or power source and may provide power information required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as the arrival of a message, promise, or proximity notification, in such a manner that does not disturb a user. The location manager 350 may manage location information of an electronic device. The graphic manager 351 may manage a graphic effect which will be provided to a user, or a user interface related to the graphic effect. The security manager 352 may provide all security functions required for system security, and user authentication. When the electronic device has a telephone call function, the middleware 330 may further include a telephony manager for managing a voice call function or a video call function of the electronic device.

The middleware 330 may include a middleware module that forms a combination of various functions of the above-described components, may provide a module specialized for each type of OS in order to provide a differentiated function, and may dynamically remove some of the existing components or add new components.

The API 360 is a set of API programming functions, and may be provided with a different configuration according to an OS. For example, in the case of Android or iOS, one API set may be provided for each platform. In the case of Tizen, two or more API sets may be provided for each platform.

The applications 370 may include one or more applications which may provide functions such as a home 371, a dialer 372, a short message service/multimedia messaging service (SMS/MMS) 373, an instant message (IM) 374, a browser 375, a camera 376, an alarm 377, contacts 378, a voice dial 379, an e-mail 380, a calendar 381, a media player 382, an album 383, a clock 384, health care (e.g., measuring exercise quantity or blood sugar), and environment information (e.g., providing atmospheric pressure, humidity, or temperature information) functions.

The applications 370 may include an information exchange application that supports exchanging information between the electronic device and an external electronic device. The information exchange application may include a notification relay application for transferring specific information to an external electronic device or a device management application for managing an external electronic device.

For example, the notification relay application may include a function of transferring, to the external electronic device, notification information generated from other applications of the electronic device 101, and may receive notification information from an external electronic device and provide the received notification information to a user.

The device management application may install, delete, or update at least one function of an external electronic device communicating with the electronic device, such as turning on/off the external electronic device or components thereof, or adjusting the brightness of the display, applications operating in the external electronic device, and services provided by the external electronic device, such as a call service or a message service.

According to an embodiment of the present disclosure, the applications 370 may include a health care application of a mobile medical appliance designated according to an external electronic device, an application received from an external electronic device, and a preloaded application or a third party application that may be downloaded from a server. The names of the components of the program module 310 of the illustrated embodiment of the present disclosure may change according to the type of OS.

At least a part of the programming module 310 may be implemented in software, firmware, hardware, or a combination of two or more thereof. At least some of the program module 310 may be executed by the processor. At least some of the program module 310 may include a module, a program, a routine, a set of instructions, and/or a process for performing one or more functions.

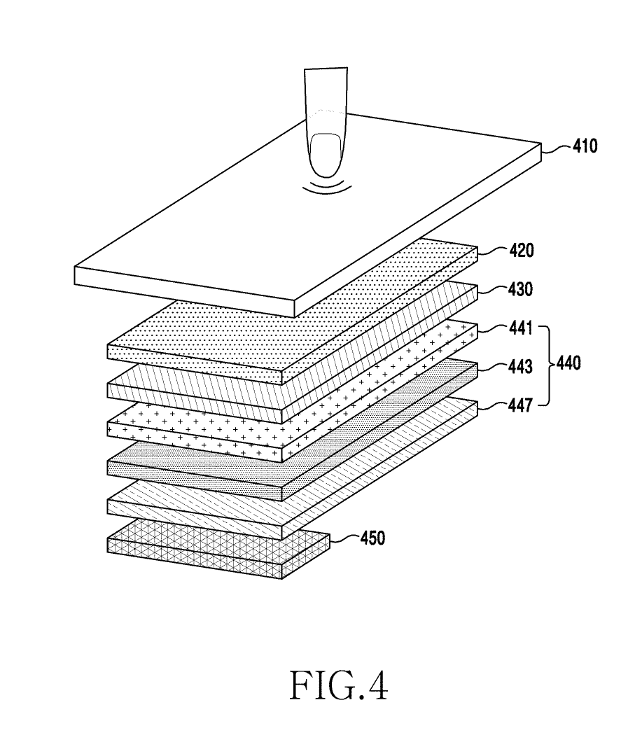

FIG. 4 is a cross-sectional view of an electronic device according to embodiments of the present disclosure. Hereinafter, the electronic device may include all or some parts of the electronic device 101 of FIG. 1.

Referring to FIG. 4, the electronic device may include a housing. A cover window 410, a touch sensor 420, a display 430, a force sensor 440, and a haptic actuator 450 may be included inside the housing.

The housing (not shown) may include a first surface directed in a first direction and a second surface directed in a second direction opposite to the first direction. Herein, the first surface may be a front surface of the electronic device, and the second surface may be a rear surface of the electronic device. In this case, the cover window 410 may be exposed through the first surface of the housing.

The touch sensor 420 may be located between the first surface and second surface of the housing, such as between the cover window 410 and the display 430. The touch sensor 420 may detect a touch point based on an external object for the display 430.

The display 430 may be located between the first surface and second surface of the housing, and may be exposed through the first surface of the housing. For example, the display 430 may be located below the touch sensor 420.

The force sensor 440 may be located between the first surface and the second surface. For example, the force sensor 440 may be located below the display 430 and may include a first electrode 441, a dielectric layer 443, and a second electrode 447. Herein, at least one of the first electrode 441 and the second electrode 447 may be constructed of a transparent material or a non-transparent material. The transparent material is conductive, and may be constructed of a compound of at least one of indium tin oxide (ITO), indium zinc oxide (IZO), silver (Ag) nanowire, metal mesh, transparent polymer conductor, and graphene, for example. The non-transparent material may be constructed of a compound of at least two of copper (Cu), silver (Ag), magnesium (Mg), and titanium (Ti). The dielectric layer 443 may include at least one of silicon, air, foam, membrane, optical clear adhesive (OCA), sponge, rubber, ink, and a polymer such as polycarbonate (PC) or polyethylene terephthalate (PET, for example.

One of the first electrode 441 and second electrode 447 of the force sensor 440 is a ground substrate, and the other of the first electrode 441 and second electrode 447 may be constructed of repetitive polygonal patterns. In this case, the force sensor 440 may detect a force in a self-capacitance manner.

One of the first electrode 441 and second electrode 447 of the force sensor 440 may have a first direction pattern TX, and the other of the first electrode 441 and second electrode 447 may have a second direction pattern RX orthogonal to the first direction. In this case, the force sensor 440 may detect a force in a mutual capacitance manner.

The first electrode 441 of the force sensor 440 may be attached to the display 430 by being formed on a flexible printed circuit board (FPCB), or may be directly formed on one surface of the display 430.

The haptic actuator 450 may provide a haptic effect to a user, such as by outputting a vibration upon detection of a user's touch input for the display 430.

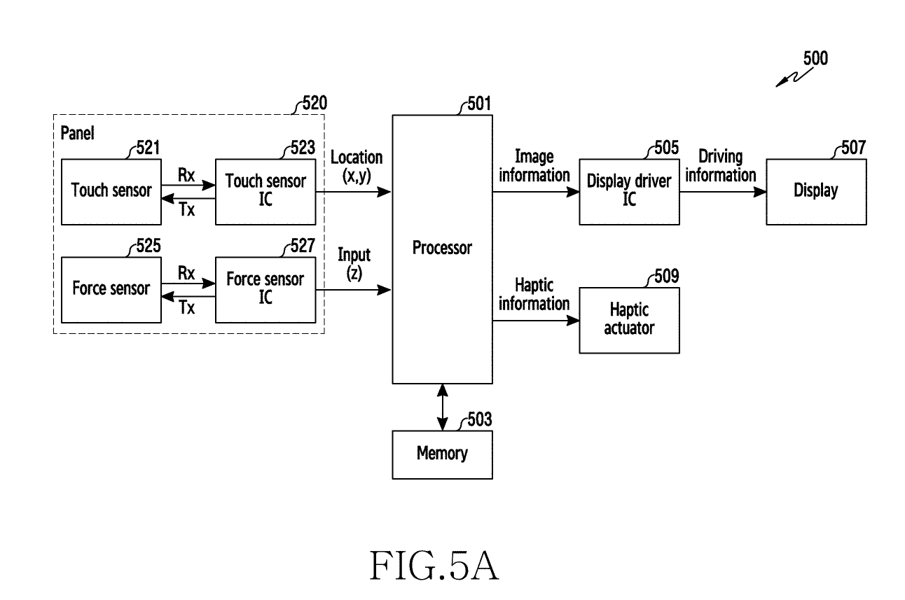

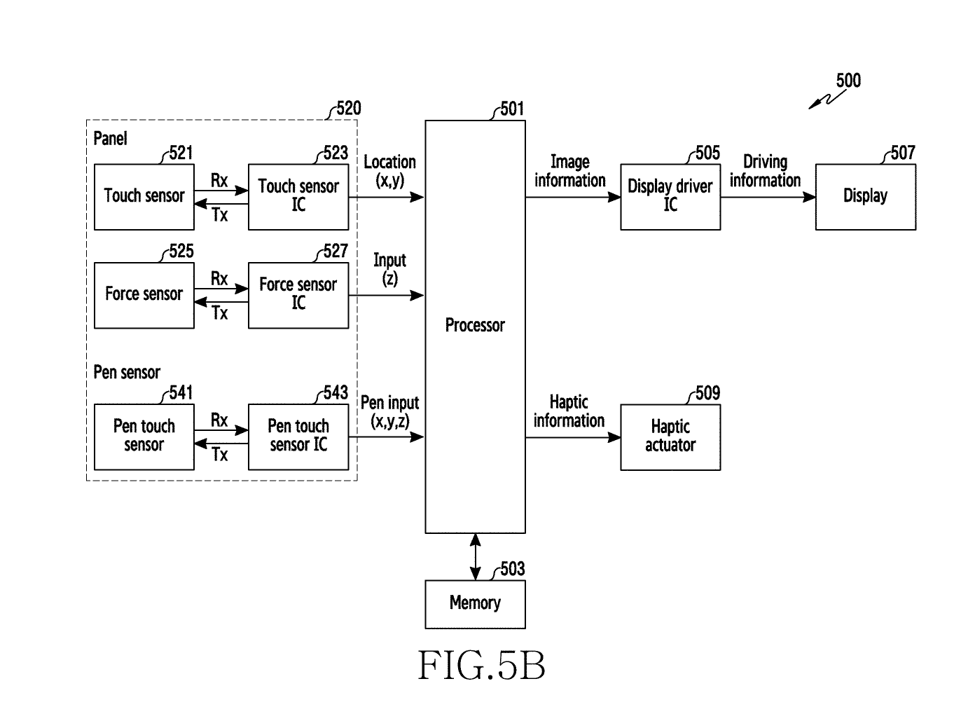

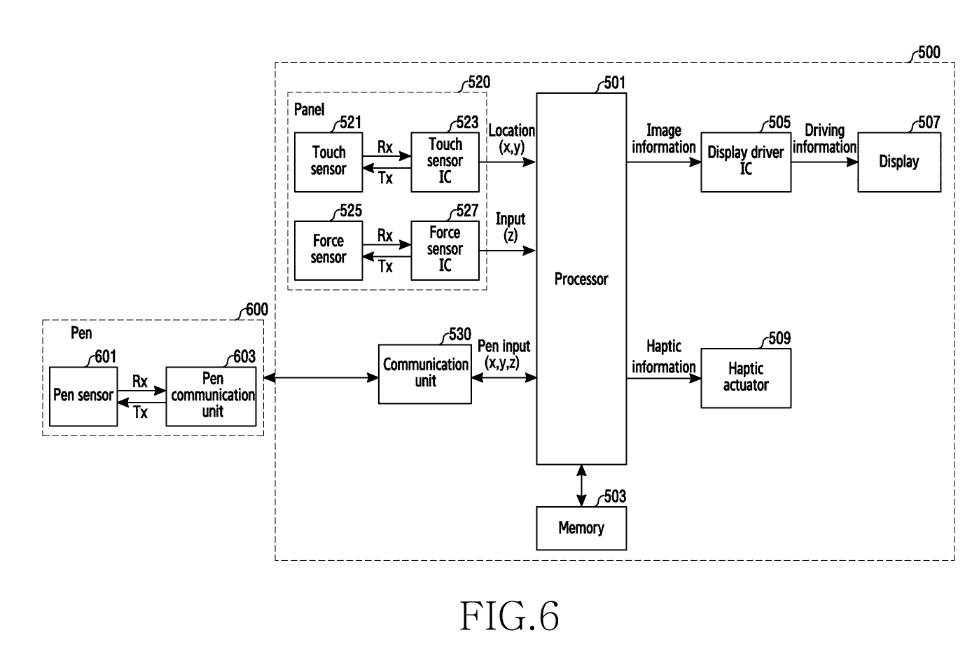

FIG. 5A and FIG. 5B illustrate a block diagram of an electronic device according to embodiments of the present disclosure. FIG. 6 illustrates a block diagram of an electronic device and a pen according to embodiments of the present disclosure. In the following description, the electronic device may include all or at least some parts of the electronic device 101 of FIG. 1.

Referring to FIG. 5A, an electronic device 500 includes a processor 501, a memory 503, a display driver IC 505, a display 507, a haptic actuator 509, and a panel 520. The panel 520 may include a touch sensor 521, a touch sensor IC 523, a force sensor 525, and a force sensor IC 527.

The processor 501 may receive a location signal, such as a coordinate (x, y), or a force signal, such as a force magnitude (z). For example, the processor 501 may receive the location signal detected from the touch sensor 521 in the panel 520 through the touch sensor IC 523. Herein, the sensor IC 523 may supply (Tx) a specific pulse to the touch sensor 521 to detect a touch input, and the touch sensor 521 may provide (Rx) the touch sensor IC 523 with the location signal by detecting a change of capacitance caused by a touch input. Alternatively, the processor 501 may receive a force signal detected from the force sensor 525 in the panel 520 through the force sensor IC 527. Herein, the force sensor IC 527 may supply (Tx) a specific pulse to the force sensor 525 to detect a force, and the force sensor 525 may provide (Rx) the force sensor IC 527 with a force signal by detecting a change of capacitance caused by the force. In this case, the processor 501 may synchronize the location signal received from the touch sensor IC 523 and the force signal received from the force sensor IC 527. The processor 501 may provide the user with a haptic effect (e.g., a vibration) through the haptic actuator 509 in response to the reception of the location signal and the force signal.

The processor 501 may provide the display driver IC 505 with image information to output an image. The display driver IC 505 may provide the display 507 with driving information to drive the display 507 based on the image information provided from the processor 501. The display 507 may output the image based on the driving information provided from the display driver IC 505.

The panel 520 may further include a pen sensor for detecting an input caused by a stylus pen. For example, as shown in FIG. 5B, the panel 520 may further include a pen touch sensor 541 for detecting a location signal caused by the stylus pen and a pen touch sensor IC 543 for providing the processor 501 with the location signal detected from the pen touch sensor 541. In this case, the processor 501 may synchronize the location signal received through the pen touch sensor IC 543 and the force signal received through the force sensor IC 527, and then may process the signals as one input.

The pen touch sensor 541 may detect both of the location and force of the input caused by the stylus pen. In this case, the processor 501 may detect the force of the input caused by the stylus pen based on at least one of the force signal received through the force sensor IC and the force signal received through the pen touch sensor IC 543.

The electronic device 500 may further include a communication unit 530, as shown in FIG. 6, for receiving input information from an external electronic device. In this case, the processor 501 may receive an input signal, such as a location or a force signal, from a pen 600 through the communication unit 530. Herein, the pen 600 may further include a pen sensor 601 for detecting coordinate information and force information corresponding to an input to provide the information to a pen communication unit 603, and the pen communication unit 603 for transmitting the coordinate information and force information provided from the pen sensor 601 to the communication unit 530 of the electronic device 500.

Although it is described above that the force sensor 525 detects only the force for the user input, according to embodiments of the present disclosure, the force sensor 525 may detect both the force for the user input and a location for the user input. For example, the panel 520 of the electronic device 500 may include a plurality of force sensors 525, and upon detection of the force caused by the user input, the location for the user input may be detected based on the detected location of the force sensor for detecting the force among the plurality of force sensors 525.

The following are aspects according to embodiments of the present disclosure, as described above. An electronic device may include a housing including a first surface directed in a first direction and a second surface directed in a second direction opposite to the first direction, a touch screen display located between the first surface and the second surface and exposed through the first surface, a force sensor located between the first surface and the second surface and detecting a force caused by an external object as to the touch screen display, a wireless communication circuit, at least one processor electrically connected to the touch screen display, the force sensor, and the wireless communication circuit, and a memory electrically connected to the processor.

The memory may include instructions, when executed, cause the processor to display a screen including at least one object on the touch screen display, receive data indicating that the external object is pressed on the touch screen display by a force greater than or equal to a selected force from at least one of the force sensor and the wireless communication circuit, receive a manual input through the touch screen display after the data is received, display at least one of an image and a character on the touch screen display in a manner overlapping with the screen based on the manual input, and delete the at least one of the image and the character while directly maintaining the screen when a selected time elapses.

The external object may include a stylus pen.

A display of the touch screen may include a touch panel. The electronic device may further include a panel separated from the touch panel and configured to detect an input caused by the stylus pen.

The instructions may allow the at least one processor to display a first layer including the at least one object on the screen and generate a second layer on which the at least one of the image and the character are displayed so that the second layer is displayed on the screen in a manner overlapping with the first layer.

The second layer may have at least one of a different location and a different size for displaying the second layer based on an input caused by the stylus pen.

The instructions may allow the at least one processor to store the image and/or the object into the memory.

The screen may include a home screen, and the object may include at least one icon for displaying an application program.

The screen may include a user interface screen of an application program, and the object may include at least one button for selecting a function.

The application program may include a telephone application program.

The instructions may allow the at least one processor to transmit the at least one of the image and the character to an external electronic device connected to the wireless communication circuit.

The instructions may allow the at least one processor to determine an update cycle for the at least one of the image and the character based on the data and to update the at least one of the image and the character according to the determined cycle.

An electronic device may include a housing including a first surface directed in a first direction and a second surface directed in a second direction opposite to the first direction, a touch screen display located between the first surface and the second surface and exposed through the first surface, a wireless communication circuit, at least one processor electrically connected to the touch screen display and the wireless communication circuit, and a memory electrically connected to the at least one processor.

The memory may include instructions, when executed, cause the processor to display a screen including at least one object on the touch screen display, receive data indicating that the external object is pressed on the touch screen display by a force greater than or equal to a selected force from an external object through the wireless communication circuit, receive a manual input through the touch screen display after the data is received, display at least one of an image and a character on the touch screen display in a manner overlapping with the screen based on the manual input, and delete the at least one of the image and the character while directly maintaining the screen when a selected time elapses.

An electronic device may include a housing including a first surface directed in a first direction and a second surface directed in a second direction opposite to the first direction, a touch screen display located between the first surface and the second surface, exposed through the first surface, and including a first panel for displaying at least one object and a second panel for detecting a touch input, a force sensor located between the first surface and the second surface and detecting a force caused by an external object as to the touch screen display, a wireless communication circuit, at least one processor electrically connected to the touch screen display, the force sensor, and the wireless communication circuit, and a memory electrically connected to the processor.

The memory may include instructions, when executed, cause the processor to receive data indicating that the external object is pressed on the touch screen display by a force greater than or equal to a selected force, when the first panel is off, from at least one of the force sensor and the wireless communication circuit, receive a manual input through the second panel after the data is received, display at least one of an image and a character based on the manual input by using the first panel, and no longer display the at least one of the image and the character on the first panel when a selected time elapses.

An electronic device may include a housing including a first surface directed in a first direction and a second surface directed in a second direction opposite to the first direction, a touch screen display located between the first surface and the second surface, exposed through the first surface, and including a first penal for displaying at least one object and a second panel for detecting a touch input, a wireless communication circuit, at least one processor electrically connected to the touch screen display and the wireless communication circuit, and a memory electrically connected to the at least one processor.

The memory may include instructions, when executed, cause the processor to receive data indicating that the external object is pressed on the touch screen display by a force greater than or equal to a selected force, when the first panel is off, from the wireless communication circuit, display at least one of at least one of an image and a character based on the manual input by using the first panel, and no longer display the at least one of the image and the character on the first panel when a selected time elapses.

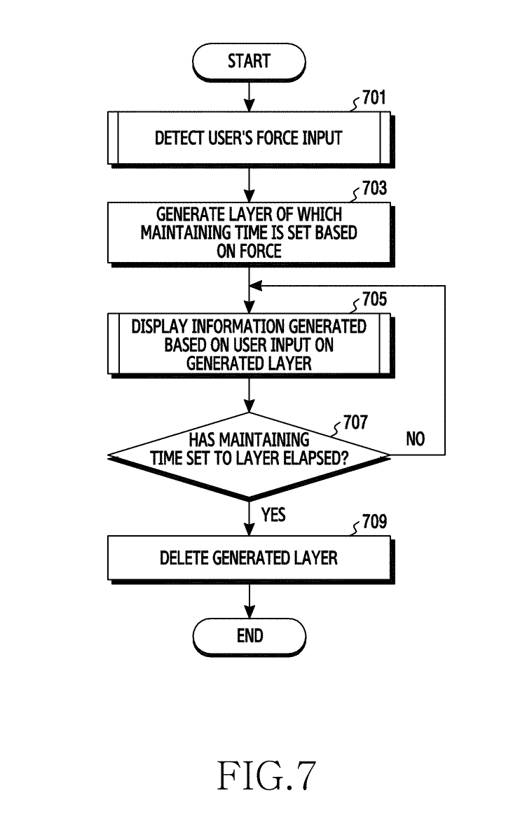

FIG. 7 illustrates a method for controlling an electronic device by using a force input in the electronic device according to embodiments of the present disclosure. In the following description, the electronic device may include the electronic device 500 of FIGS. 5A and 5B and FIG. 6.

Referring to FIG. 7, in operation 701, the processor may detect a user's force input for a touch screen. For example, referring back to FIGS. 5A and 5B, the processor 501 may detect the user input through the touch sensor 521 when the display 507 is off, when the display 507 is displaying a main screen, or when an application is running in the electronic device 500. For example, if a part of a user's body or the pen 600 is in contact with the display 507 when a display function of the display 507 is off, the processor 501 may determine that the user input is detected.

Herein, irrespective of whether the display function of the display 507 is on/off, the processor 501 may control the panel 520 to perform an always on display (AOD) function for maintaining an active state of the touch sensor 521 and an always on force (AOF) function for maintaining an active state of the force sensor 525. Alternatively, if the pen 600 is in contact with the display 507, the processor 501 may detect the user input by receiving input information transmitted from the pen 600 through the communication unit 530. The processor 501 may determine whether the detected user input is the force input. For example, the processor 501 may determine whether a movement amount of the detected user input is less than or equal to a first threshold. If the movement amount of the detected user input is less than or equal to the first threshold, the processor 501 may detect a force caused by the user input for the display 507. For example, the processor 501 may detect the force caused by the user input for the display 507 by using the force sensor 525 included in the panel 520, or may detect a force by receiving force information measured by the pen sensor 601 included in the pen 600 through the communication unit 530 of the electronic device 500. If the force caused by the user input for the display 507 is greater than or equal to a second threshold, the processor 501 may determine whether the user input is released. If the user input is moved instead of being released, the processor 501 may determine the user input as the force input.

For example, in order to determine whether the user input is the force input, the processor 501 may use an average value, maximum value, or minimum value of the force caused by the user input for the display 507 for a pre-defined time. Herein, the first threshold, the second threshold, and the pre-defined time may be changed based on a user's configuration.

The processor 501 may determine whether the user input is the force input by using only the force caused by the user input for the display 507. For example, upon detection of the user input for the display 507, the processor 501 may confirm the force caused by the user input for the display 507. If the confirmed force is greater than the second threshold, the processor 501 may determine the user input as the force input.

Returning to FIG. 7, in operation 703, the processor may generate a layer of which a maintaining time is set based on a force caused by a user input for a touch screen in response to the detection of the user's force input. For example, upon detection of the user's force input, the processor 501 may generate a layer which is set to be maintained for a time corresponding to the force caused by the user input for the display 507. For example, the processor 501 may generate the layer such that the greater the force caused by the user input for the display 507, the longer the maintaining time set to the layer.

In operation 705, the processor may display information generated based on the user input on the generated layer. For example, if the layer is generated, the processor 501 may load and execute a recognition engine for detecting a persistent (i.e., continuous) user input from the memory 503. The processor 501 may store a stroke generated from the user input through the executed recognition engine into the memory 503, and may display the stroke on the generated layer.

In operation 707, the processor may determine whether a maintaining time set to the generated layer elapses. For example, the processor 501 may determine whether one minute elapses from a time at which a layer set to be maintained for one minute based on the force caused by the user input for the display 507 is displayed on the touch screen.

If it is determined in operation 707 that the maintaining time set to the generated layer has not elapsed, the processor may continuously perform the operation 705 for displaying the input information on the generated layer. For example, if the maintaining time set to the generated layer is one minute, the processor 501 may continuously display the input information on the generated layer based on the user input on the display 507 until one minute elapses.

Upon detection of the user input for the generated layer when the maintaining time set to the generated layer has not elapsed, the processor may return to operation 705 and provide the user's input information to the generated layer based on a user's input type (e.g., a touch input caused by a finger or an input caused by a stylus pen), or may bypass the information and provide the information to a next layer of the generated layer.

For example, upon detection of the touch input caused by the user's finger as to the generated layer, the processor 501 may bypass touch input information and provide it to a next layer of the generated layer. For example, upon detection of the user's touch input for the generated layer when a layer of a telephone application is located next to the generated layer, the processor 501 may provide the touch input information to the layer of the telephone application. Alternatively, upon detection of an input caused by the pen 600 as to the generated layer, the processor 501 may provide the input information to the generated layer, such as by changing a graphic element such as a size, location, transparency, or brightness of the generated layer or information included in the layer, based on the input caused by the pen 600.

In operation 709, if it is determined that the maintaining time set to the generated layer has elapsed, the processor may delete the generated layer. For example, if the maintaining time set to the generated layer is one minute, the processor 501 may delete the generated layer when one minute elapses from a time point of displaying information generated based on the user input on the generated layer.

Although it is described above that the generated layer is deleted when the maintaining time elapses, according to embodiments of the present disclosure, if it is determined in operation 707 that the maintaining time set to the generated layer elapses, the processor may output a selection screen to the display 507 to determine whether to delete the generated layer. For example, if the maintaining time set to the generated layer is one minute, when one minute elapses from a time point of displaying the generated information based on the user input on the generated layer, the processor 501 may display the selection screen on the display 507 to inquire whether to delete the generated layer, and may delete the generated layer based on the user input for the selections screen.

Although it is described above that the maintaining time of the layer generated based on the force caused by the user input for the touch screen is set, in operation 703, the processor may generate a layer which is maintained for a pre-set time duration in response to the detection of the user's force input. For example, upon detection of the user's force input, the processor 501 may generate a layer which is maintained for one minute irrespective of a magnitude of a force caused by a user input for the display 507. In this case, the processor 501 may change a graphic element such as a color, size, brightness, lightness of a layer generated based on the force caused by the user input for the display 507.

Although it is described above that the maintaining time of the layer is set based on the force caused by the user input for the touch screen, in operation 705, the processor may determine the number of times a screen of the layer is changed based on the force caused by the user input for the touch screen.

For example, in operation 707, the processor 501 may determine whether the number of times the screen displayed on the display 507 is changed exceeds the number of times a screen set to the layer is changed. If the number of times the screen displayed on the display 507 is changed exceeds the number of times the screen set to the layer is changed, the processor 501 may delete the generated layer.

The processor may determine not only the maintaining time of the layer but also the graphic element of the layer based on the user's force for the touch screen. For example, the processor 501 may generate a non-transparent layer having an extended maintaining time when the user's force on the display 507 is high. In this case, the processor 501 may control the graphic element of the layer so that the generated layer gradually becomes transparent. For another example, the processor 501 may generate a layer having an extended maintaining time and having brighter color when the user's force on the display 507 is high. In this case, the processor 501 may provide control such that the graphic element of the layer gradually darkens over time.

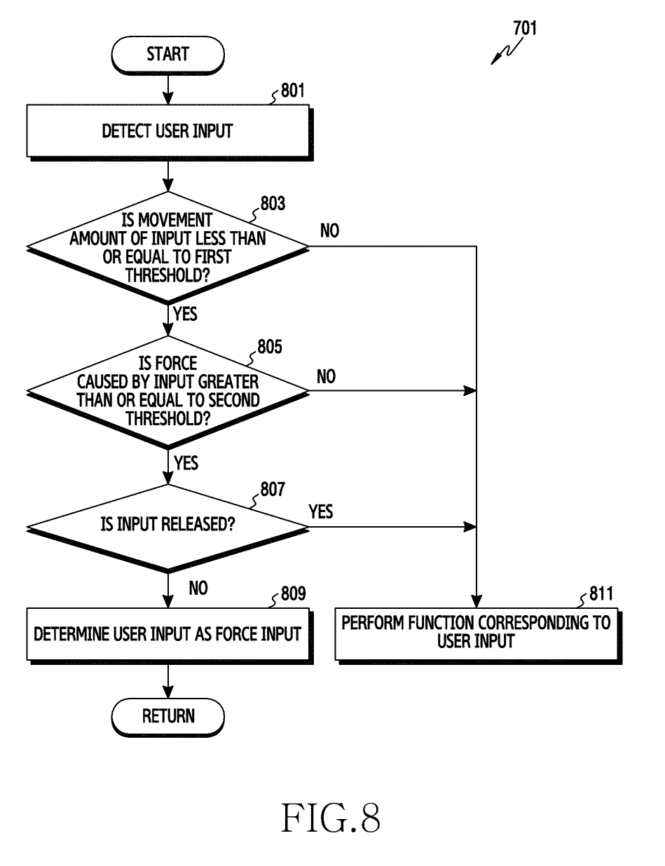

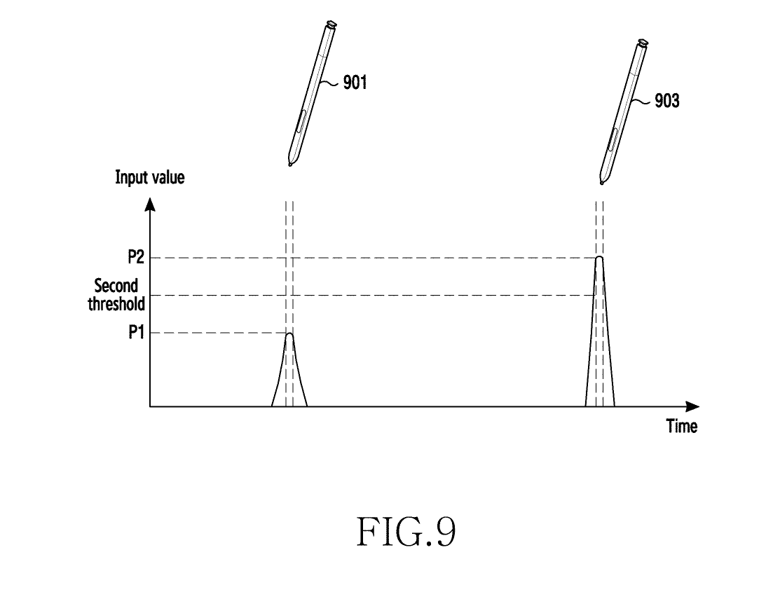

FIG. 8 illustrates a method for detecting a force input in an electronic device according to embodiments of the present disclosure. FIG. 9 illustrates an example of determining an input force in an electronic device according to embodiments of the present disclosure. In FIG. 8, an operation of detecting a user's force input in the operation 701 of FIG. 7 is described, and reference will be made to the electronic device 500 of FIGS. 5A and 5B and FIG. 6.

Referring to FIG. 8, a processor may detect a user input in operation 801. For example, the processor 501 may detect the user input for the display 507 through the touch sensor 521, through the force sensor 525, or by receiving input information transmitted from the pen 600 through the communication unit 530.

The processor may determine whether a movement amount of the detected user input is less than or equal to a first threshold in operation 803. For example, the processor 501 may detect the movement amount of the user input for the display 507 by using the touch sensor 521 or the pen touch sensor 541, or by receiving input information measured in the pen sensor 601 included in the pen 600 through the communication unit 530. The processor 501 may compare the detected movement amount with a pre-set first threshold to determine whether the movement amount of the user input is less than or equal to the first threshold. Herein, the first threshold may be changed depending on a user's configuration.

If the movement amount of the user input for the touch screen exceeds the first threshold, the processor proceeds to operation 811 to perform a function corresponding to the user input. For example, if the user input for the display 507 exceeds the first threshold, the processor 501 may determine that the user input is not the force input. If the user input is not the force input, the processor 501 may perform a function mapped to a coordinate corresponding to the user input. For example, if a coordinate corresponding to the user input is located at an execution icon of a telephone application, the processor 501 may execute the telephone application, and may end the present algorithm after performing the function corresponding to the user input.

If the movement amount of the user input is less than or equal to the first threshold, in operation 805, the processor may determine whether a force caused by the user input is greater than or equal to a second threshold, such as by detecting the force for a pre-set time duration from a time point at which the user input is detected by using the force sensor 525. The processor 501 may determine any one of a maximum value, a minimum value, and an average value of the force detected during the pre-set time duration as the force caused by the user input. The processor 501 may compare the determined force with the pre-set second threshold to determine whether the force caused by the user input is greater than or equal to the second threshold. Herein, the second threshold and the pre-set time may be changed depending on a user's configuration.

If the force caused by the user input is less than the second threshold, the processor may proceed to operation 811 to perform the function corresponding to the user input. For example, if the force caused by the user input for the touch screen is less than the second threshold, the processor 501 may determine that the user input is not the force input. For example, as shown in FIG. 9. If a maximum value P1 of a force caused by the stylus pen 901 is less than the second threshold, the processor 501 may determine that an input caused by the stylus pen 901 is not the force input, and may end the present algorithm after performing a function mapped to a coordinate corresponding to the user input.

If the force caused by the user input is greater than or equal to the second threshold, in operation 807, the processor may determine whether the user input is released. For example, as shown in FIG. 9, if a maximum value P2 of a force caused by a stylus pen 903 is greater than or equal to the second threshold, the processor 501 may determine whether an input caused by the stylus pen 903 is released.

If the user input is released, the processor 501 may proceed to operation 811 to perform the function corresponding to the user input. For example, in case of being released, instead of being moved, when the input caused by the user input is greater than or equal to the second threshold, the processor 501 may determine that the user input is not the force input. The processor 501 may end the present algorithm after performing a function corresponding to the user input in response to the determining that the user input is not the force input.

In operation 809, if the user input is not released, the processor 501 may determine the user input as the force input. In this case, the processor 501 may determine that the user's force input is detected in response to the determining that the user input is the force input.

Although an operation of determining a force input is described above in determining one user input, according to embodiments of the present disclosure, the processor may determine the force input even if a plurality of user inputs are simultaneously detected. For example, if an input caused by the pen 600 and an input caused by a user's finger are simultaneously detected, the processor 501 may determine whether to input a force based on a force of an input caused by the user's finger, or may determine whether to input a force based on the force caused by the pen 600. In this case, the processor 501 may distinguish the input caused by the pen 600 and the input caused by the user's finger through the touch sensor 521 and the pen touch sensor 541.

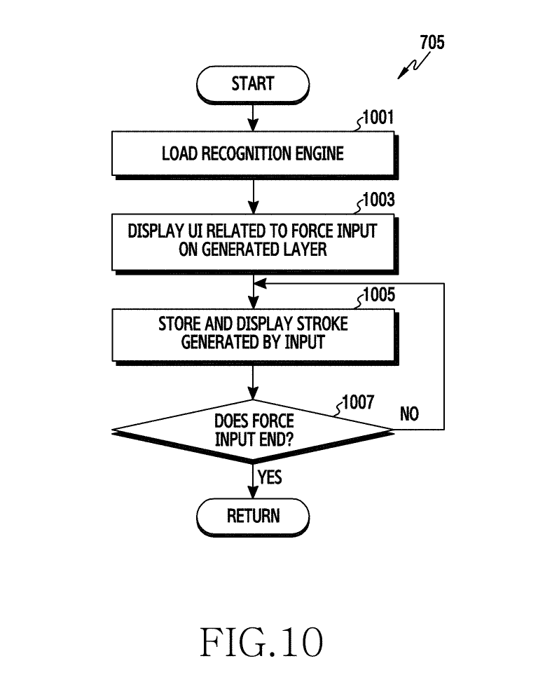

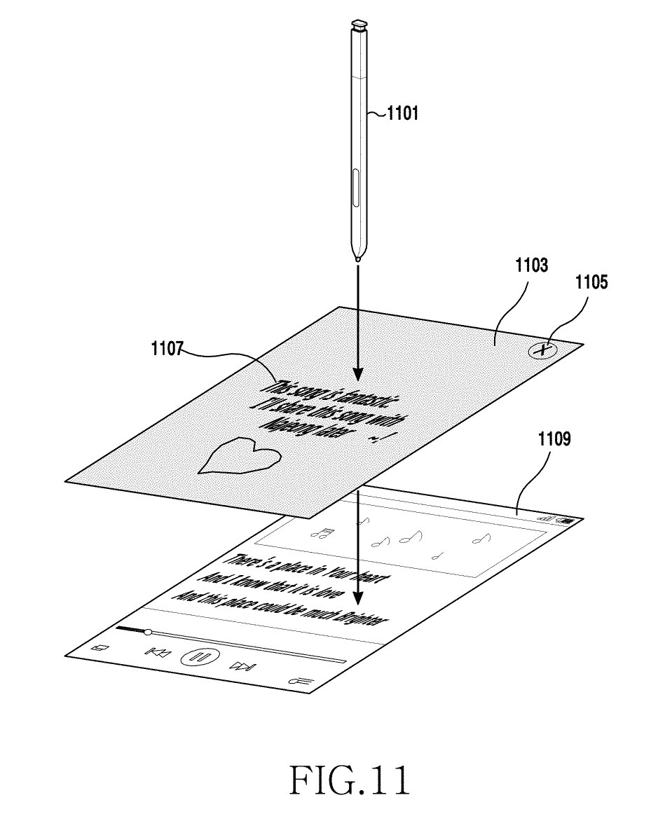

FIG. 10 illustrates a method for displaying information generated based on a user input on a layer displayed on a touch screen in an electronic device according to embodiments of the present disclosure. FIG. 11 illustrates a configuration of a layer based on a force input in an electronic device according to embodiments of the present disclosure. The method of FIG. 10 regards operation 705 of FIG. 7.

Referring to FIG. 10, in operation 1001, a processor may load a recognition engine from a memory of an electronic device upon generation of a layer of which a maintaining time is set based on a force. For example, as shown in FIG. 11, upon generation of a layer 1103 of which a maintaining time is set based on a force on a layer 1109 of a running application in the electronic device 500, the processor 501 may load the recognition engine to detect a persistent input of a stylus pen 1101 from the memory 503. Herein, the recognition engine may include a program for detecting a stroke generated based on a persistent (i.e., continuous) user input.

In operation 1003, the processor may display a user interface (UI) related to the force input on the generated layer. For example, if the recognition engine is loaded, as shown in FIG. 11, the processor 501 may display an end button 1105 to end the force input on one region of the generated layer 1103, or may display a control button to change a graphic element, such brightness, resolution or transparency of the generated layer 1003 on one region of the generated layer 1103.

In operation 1005, the processor may display a stroke generated based on a user input into the memory, and thereafter may display the stroke on the generated layer. For example, as shown in FIG. 11, the processor 501 may confirm a coordinate corresponding to an input of the stylus pen 1101 through the pen touch sensor 541, may store a stroke generated based on the confirmed coordinate value into the memory 503, and thereafter, may display the stroke on the layer (see 1107). In this case, the processor 501 may regulate a graphic element of the layer 1003 on which the stroke is displayed to be distinguished from the layer 1109 of a running application.

In operation 1007, the processor may determine whether the force input ends. For example, upon detection of a user input for a user interface (e.g., an end button) related to the force input, or if the user input is not detected during a pre-set time, the processor 501 may determine that the force input ends.

If the user input does not end, the processor may return to operation 1005 to store and display the stroke generated based on the user input. For example, if the user input for the user interface (e.g., the end button) related to the force input is not detected, the processor 501 may continuously perform the operation of storing and displaying the stroke generated by the user input, or may continuously perform the operation of storing and displaying the stroke generated by the user input.

Although it is described above that the recognition engine is loaded and thereafter the user interface related to the force input is displayed on the generated layer, according to embodiments of the present disclosure, the processor may display the user interface related to the force input on the generated layer and thereafter may load the recognition engine. Alternatively, the processor may simultaneously perform an operation of loading the recognition engine and an operation of displaying the user interface related to the force input on the generated layer.

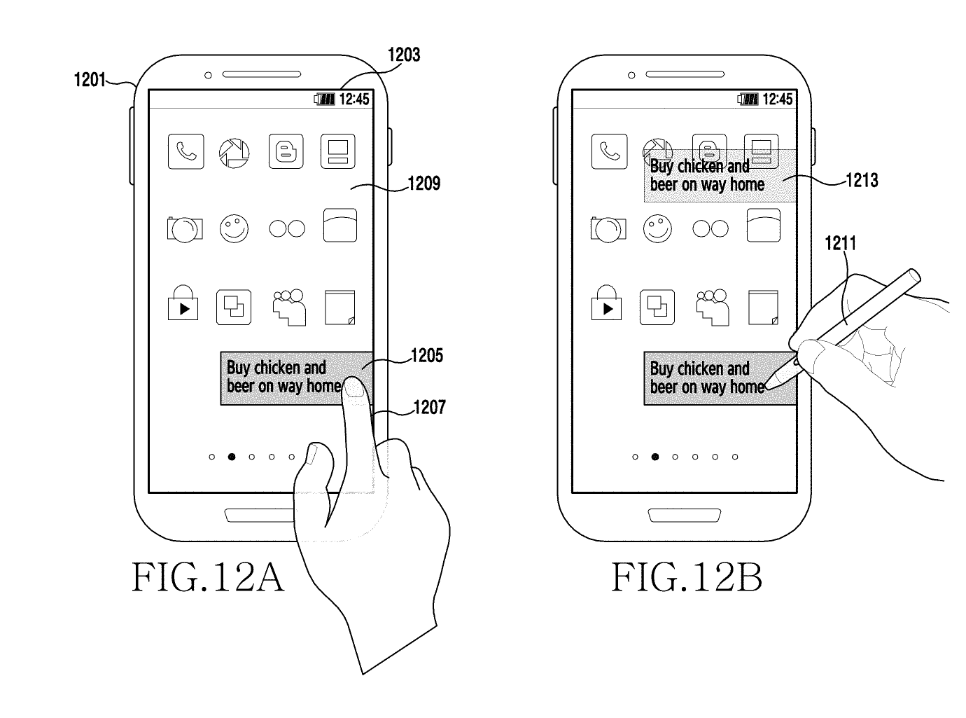

FIG. 12A and FIG. 12B illustrate an example of controlling a layer on which a stroke is displayed based on a user input in an electronic device according to embodiments of the present disclosure.

Referring to FIG. 12A, an electronic device 1201 may detect a touch input 1207 caused by a user's finger as to a layer 1205 on which a stroke is displayed from a touch screen 1203 of the electronic device 1201. In this case, the electronic device 1201 may bypass information regarding the touch input 1207 caused by the user's finger in the layer 1205 on which the stroke is displayed. The electronic device 1201 may perform a function of mapping to a coordinate for the touch input with respect to a next layer 1209 of the layer 1205 on which the stroke is displayed.

Referring to FIG. 12B, the electronic device 1201 may detect an input 1211 caused by a stylus pen as to a layer on which a stroke is displayed in the touch screen 1203. In this case, upon detection of the input caused by the stylus pen, the electronic device 1201 may move a location of the layer 1205 on which the stroke is displayed based on a coordinate at which the stylus pen is input. For example, the electronic device may locate the layer 1213 on which the stroke is displayed on an upper portion of the touch screen 1203 based on the input of the stylus pen.

Although it is described that the layer 1205 on which the stroke is displayed is moved upon detection of the input 1211 caused by the stylus pen, according to embodiments of the present disclosure, the electronic device 1201 may move the layer 1205 on which the stroke is displayed upon detection of the touch input 1207 caused by the user's finger. In this case, upon detection of the input 1211 caused by the stylus pen in FIG. 12B, the electronic device 1201 may perform an operation of bypassing a corresponding input in the layer on which the stroke is displayed.

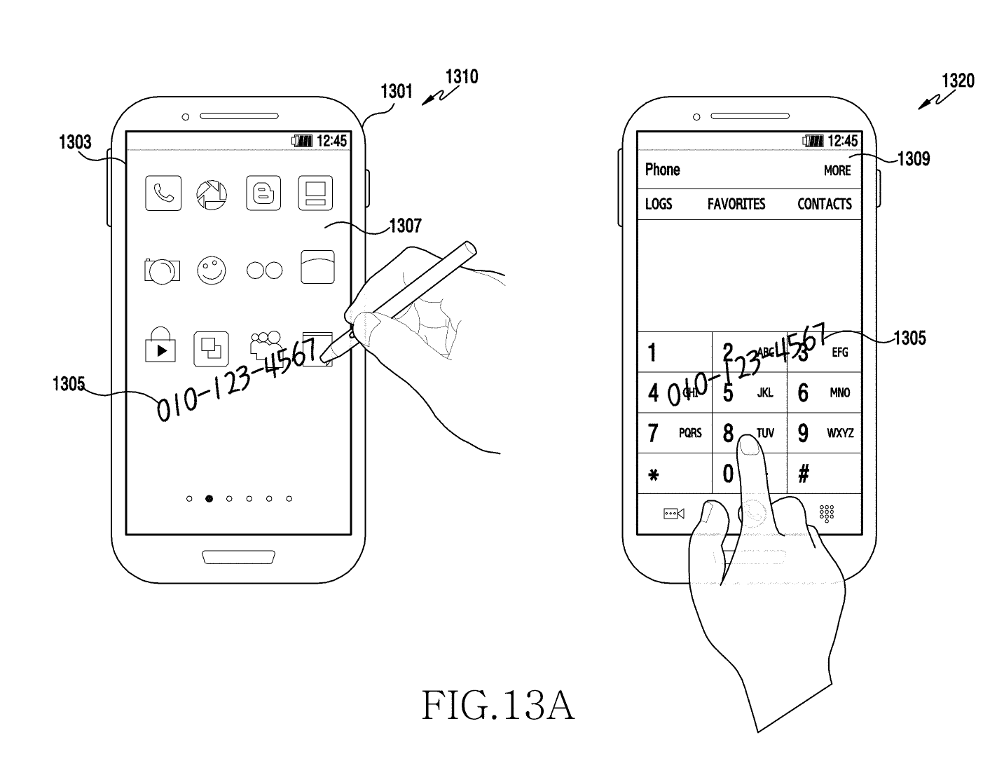

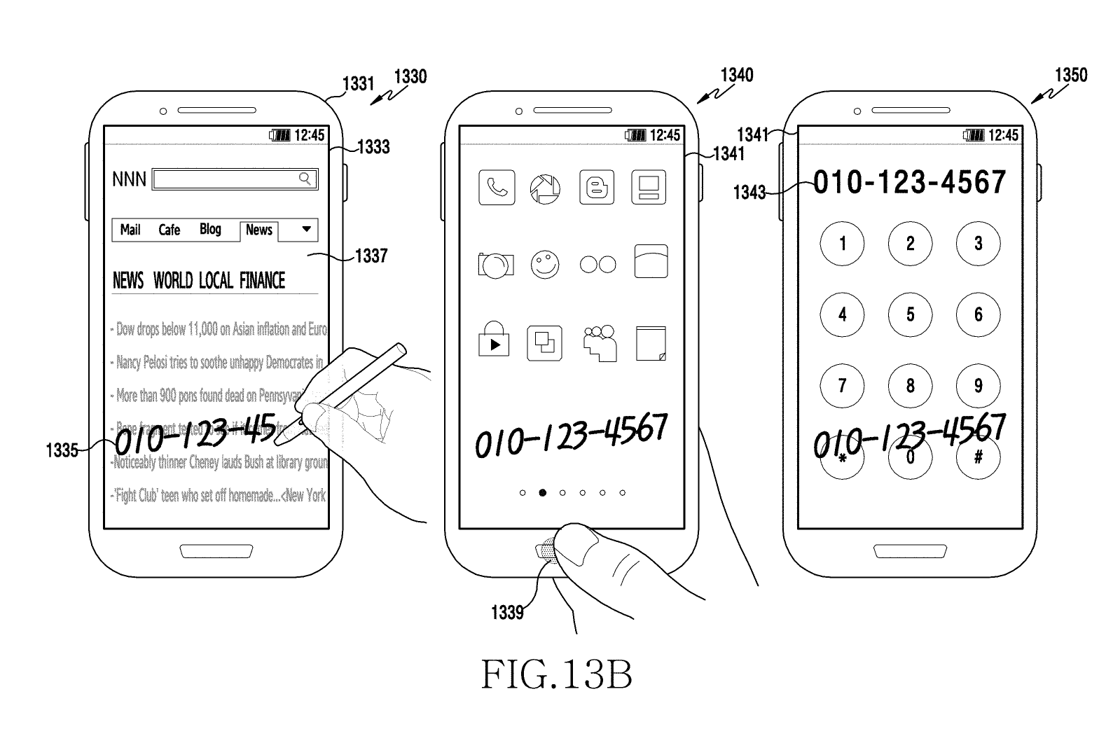

FIG. 13A and FIG. 13B illustrate an example of performing a telephone function by using a force input in an electronic device according to embodiments of the present disclosure.

Referring to 1310 of FIG. 13A, if a stylus pen input detected through the touch screen is the force input, an electronic device 1301 may generate a transparent layer 1305 on which a telephone number input through the stylus pen is displayed. The electronic device 1301 may display the transparent layer 1305, on which the telephone number is displayed, on a layer 1307 of a home screen. In this case, the electronic device 1301 may determine a time of displaying the transparent layer 1305 on which the telephone number is displayed based on a force caused by an input of the stylus pen as to the touch screen, and may set the determined time as a time of maintaining the transparent layer 1305 on which the telephone number is displayed. Thereafter, as indicated by 1320 of FIG. 13A, the electronic device 1301 may execute a telephone application in response to the detection of the user input for executing the telephone application. In this case, the electronic device 1301 may display the transparent layer 1305, on which the telephone number is displayed, on the layer 1309 of the telephone application since the maintaining time set to the transparent layer 1303 on which the telephone number is displayed has not elapsed. Accordingly, when the telephone application is used, the user of the electronic device 1301 may input a telephone number by referring to the transparent layer 1305 on which the telephone number is displayed.

For example, upon detection of the touch input caused by the user's finger as to a number pad displayed on the touch screen, the electronic device 1301 may input the telephone number as to the telephone application based on the touch input caused by the user's finger. In this case, upon detection of the touch input of the user as to the transparent layer 1303 on which the telephone number is displayed, the electronic device 1301 may bypass touch input information and provide the touch input information to a layer of the telephone application, and thus the user can input the telephone number without interference from the transparent layer 1305 on which the telephone number is displayed.

Referring to 1330 of FIG. 13B, upon detection of a force input caused by a stylus pen through a touch screen 1333 during execution of a web search application, an electronic device 1331 may generate a transparent layer 1335 on which the telephone number input by the stylus pen is displayed on a layer 1337 of the web search application. In this case, the electronic device 1331 may set a maintaining time of the transparent layer 1335 on which the telephone number is displayed based on the force of the stylus pen as to the touch screen 1333.

As indicated by 1340 of FIG. 13B, upon detection of a user input 1339 (e.g., a home button input) for changing to a home screen before the maintaining time set to the transparent layer 1335 on which the telephone number is displayed elapses, the electronic device 1331 may change to the home screen while maintaining the displaying of the transparent layer 1335 on which the telephone number is displayed, which may be located on a layer 1341 of the home screen. As indicated by 1350 of FIG. 13B, if the telephone application is running when the home screen is displayed, the electronic device 1331 may confirm the telephone number from the transparent layer 1335 on which the telephone number is displayed, and thus may automatically input the telephone application (see 1343). For example, the electronic device 1331 may confirm information included in the transparent layer 1335 on which the telephone number is displayed, may classify number information related to the telephone number included in the conformed information, and may automatically input the classified number information to the telephone application (see 1341).

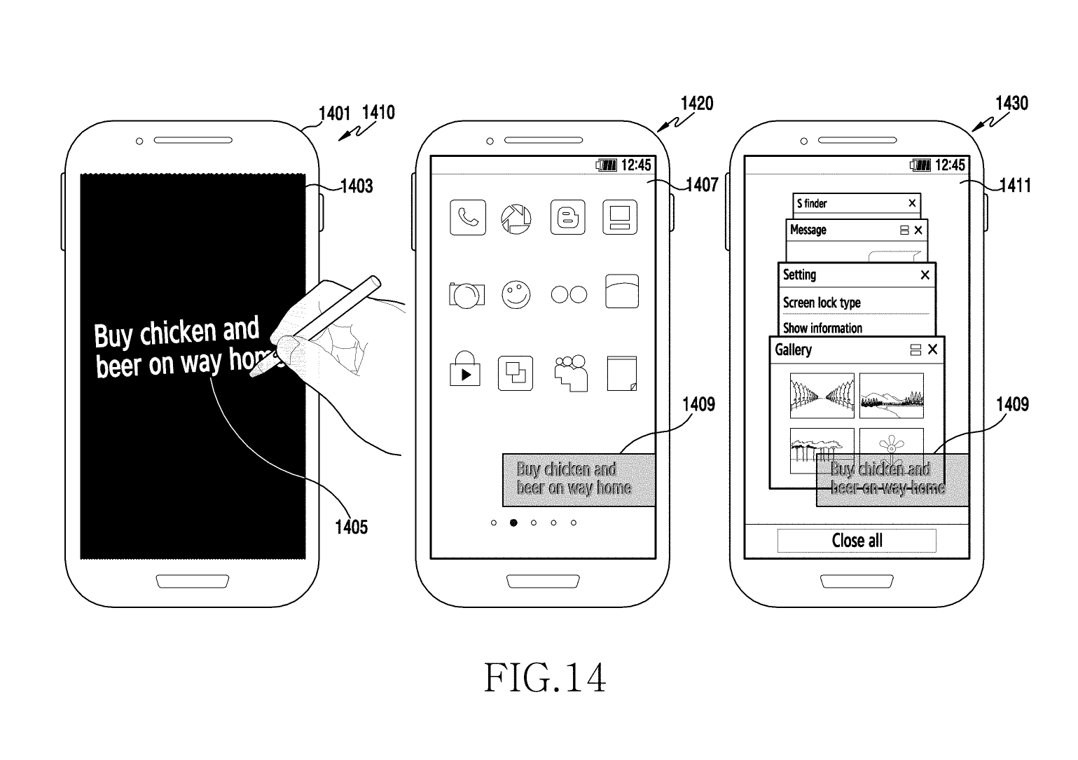

FIG. 14 illustrates an example of performing a memo function by using a force input in an electronic device according to embodiments of the present disclosure.

Referring to 1410 of FIG. 14, an electronic device 1401 may detect a force input caused by a stylus pen in a state 1403 where the displaying of a touch screen is off. For example, the electronic device 1401 may detect a location of the stylus pen through an AOD function for detecting the input caused by the stylus pen in the state 1403 where the displaying of the touch screen is off, and may detect a force caused by the stylus pen through an AOF function for detecting the force caused by the stylus pen also in the state 1403 where the displaying of the touch screen is off.

The electronic device may determine whether the input caused by the stylus pen is the force input based on the detected location of the stylus pen and the force caused by the stylus pen. The electronic device 1401 may display on the touch screen a transparent layer 1405 including a memo based on the input of the stylus pen in response to the detection of the force input caused by the stylus pen. In this case, the electronic device 1401 may set a maintaining time of the transparent layer 1405 based on the force caused by the stylus pen as to the touch screen. For example, the electronic device 1401 may set the maintaining time of the transparent layer 1405 such that the greater the force caused by the stylus pen as to the touch screen, the longer the maintaining time.

Upon detection of an input for executing an application which uses the touch screen of the electronic device 1401 before the maintaining time of the transparent layer 1405 elapses, the electronic device 1401 may display the transparent layer 1405 on a layer of the application. For example, as indicated by 1420 of FIG. 14, the electronic device 1401 may output a transparent layer 1409 on the layer 1407 of a home screen in response to the detection of the user input for outputting the home screen before the maintaining time of the transparent layer 1405 elapses. For example, the electronic device 1401 may change a graphic element such as a size or font of a character displayed on the transparent layer 1405, color, transparency, or brightness, and may display the transparent layer 1409 of which a graphic element is changed on one region of the home screen. Alternatively, the electronic device 1401 may output the transparent layer 1409 of which the graphic element is changed on a layer 1411 of a multi-window in response to the detection of an input for displaying the multi-window for changing the application before a time of maintaining the transparent layer 1405 elapses.

Herein, the transparent layer 1409 of which the graphic element is changed may be configured to bypass a touch input caused by a part of a user's body and to perform only an input caused by the stylus pen. For example, upon detection of the touch input caused by the finger, the electronic device 1401 may provide touch input information on a layer located behind the transparent layer 1409 of which the graphic element is changed. Alternatively, upon detection of the input caused by the stylus pen, the electronic device 1401 may move a location for displaying the transparent layer 1409 of which the graphic element is changed based on the input caused by the stylus pen. If a maintaining time set to the transparent layer 1409 of which the graphic element is changed elapses, the electronic device 1401 may delete the transparent layer 1409 of which the graphic element is changed. For example, if the maintaining time set to the transparent layer 1409 of which the graphic element is changed elapses while a web search application is being executed, the electronic device 1401 may delete the transparent layer 1409 of which the graphic element is changed and may display only the layer of the web search application.

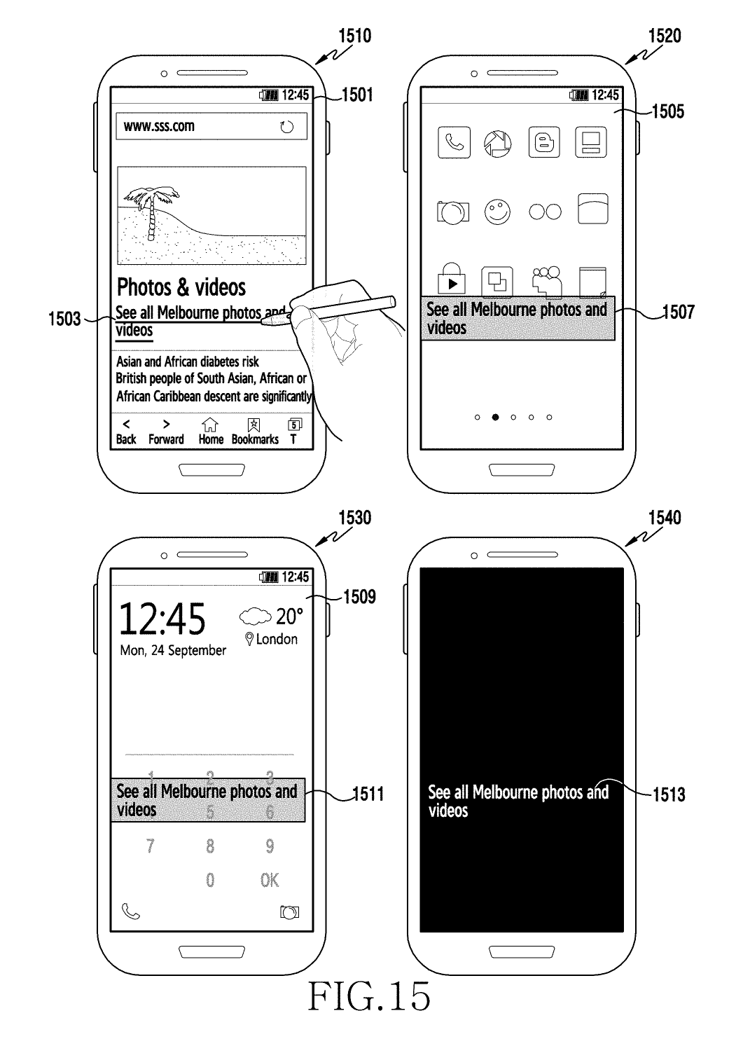

FIG. 15 illustrates an example of displaying information marked based on a force input in another electronic device according to embodiments of the present disclosure.

Referring to 1510 of FIG. 15, an electronic device 1501 may determine whether a stylus pen input 1503 for marking a specific character is the force input while a web search application is being executed. If the stylus pen input 1503 is the force input, the electronic device 1501 may determine a specific-size area including a character marked by the stylus pen. For example, the electronic device 1501 may determine the specific-size area to include a character underlined by the stylus pen based on the force caused by the stylus pen among characters or images marked in the web search application. The electronic device 1501 may increase a size of a region such that the greater the magnitude of a force caused by the stylus pen, the greater the increased size of the region.

Alternatively, the electronic device 1501 may determine a region having a specific size and including a character underlined based on a time at which the stylus pen input 1503 is in contact with the touch screen. The electronic device 1501 may increase the size of the region such that the longer the time at which the input 1503 of the stylus pen is in contact with the touch screen, the greater the increased size of the region. Upon detection of the region having the specific size and including the character underlined by the stylus pen, the electronic device 1501 may generate a transparent layer including the determined character. Upon reception of an input for changing to the home screen while the web search application is being executed, an input for changing to another application or for turning off the displaying of the touch screen, the electronic device 1501 may display the generated transparent layer on the touch screen.

For example, as indicated by 1520 of FIG. 15, upon reception of the user input for changing to the home screen, the electronic device 1501 may display a generated transparent layer 1507 on a layer 1505 of the home screen. Alternatively, as indicated by 1530 of FIG. 15, upon reception of an input for changing to the telephone application, the electronic device 1501 may display a transparent layer 1511 on the layer 1509 of the telephone application. As indicated by 1540 of FIG. 15, upon reception of an input for turning off the displaying of the touch screen, the electronic device 1501 may display only a region of a transparent layer 1513 in the touch screen, and may turn off the remaining regions.

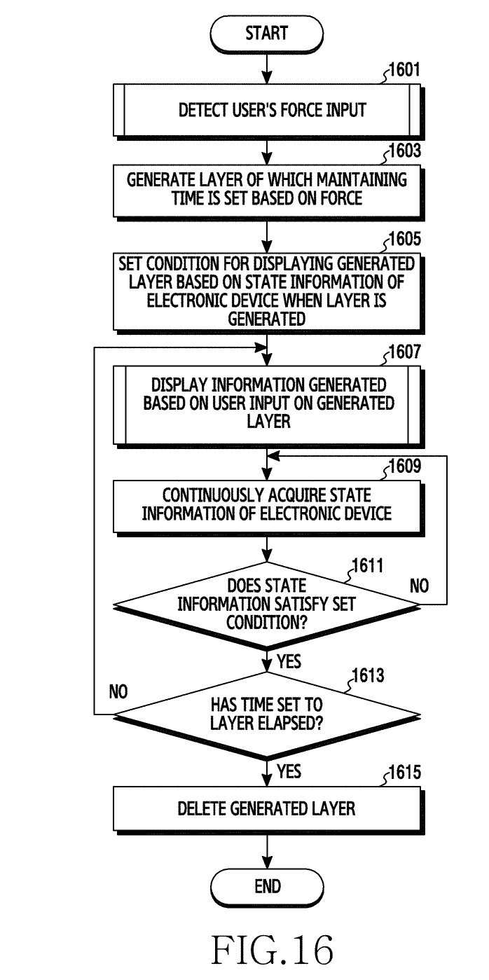

FIG. 16 illustrates a method of controlling an electronic device by using a force input based on state information of the electronic device in the electronic device according to embodiments of the present disclosure.

Referring to FIG. 16, in operation 1601, a processor may detect a user's force input. For example, as shown in operation 701 of FIG. 7, the processor 501 may detect the user input when a display function of the display 507 is off or when the display function of the display 507 is on (e.g., when a main menu is displayed or when an application is running) Upon detection of the user input, the processor 501 may confirm a movement amount of the detected user input, a magnitude of a force on the display 507, and whether to release the input. The processor 501 may determine whether the user input is the force input based on the movement amount of the detected user input, the magnitude of the force caused by the display 507, and whether to release the input. If the user input is the force input, the processor 501 may determine that the user's force input is detected.

In operation 1603, the processor may generate a layer of which a maintaining time is set based on the force caused by the user input for the touch screen in response to the detection of the user's force input. For example, as shown in the operation 703 of FIG. 7, upon detection of the user's force input, the processor 501 may confirm a time corresponding to the force caused by the user input on the display 507. The electronic device may generate the layer which is set to be maintained for the confirmed time.

In operation 1605, when the layer is generated, the processor may set a condition of displaying the generated layer based on state information of the electronic device. In examples, if the layer is generated while content is reproduced through a music application, the processor 501 may set the condition of displaying the layer such that the generated layer is displayed only while the content in the layer generation is reproduced. If the layer is generated while a game application is driven, the processor 501 may set the condition of displaying the layer such that the generated layer is displayed only while the game application executed in the layer generation is driven. If the layer is generated based on a force input for the display 507 exposed through one portion of a cover when the cover of the electronic device 500 is closed, the processor 501 may set the condition of displaying the layer such that the generated layer is generated only while the cover of the electronic device 500 is closed. If the layer is generated during communication is achieved with an external electronic device such as a wearable device or a smart TV, the processor 501 may set the condition of displaying the layer such that the generated layer is displayed only while communication is achieved with the external electronic device of which communication is achieved in the layer generation.

In operation 1607, the processor may display information generated based on the user input on the generated layer. For example, as shown in operation 705 of FIG. 7, the processor 501 may store a stroke generated from the user input into the memory 503 by loading a recognition engine from the memory 503, and may display the stroke on the generated layer.

In operation 1609, the processor may continuously acquire state information of the electronic device. For example, the processor 501 may continuously confirm at least one state among a type of an application executed in the electronic device 500, a type of content provided through the application, a cover state of the electronic device 500, and a communication state of the communication unit 530, such as information regarding an external electronic device communicating with the electronic device 500.

In operation 1611, the processor may confirm whether the acquired state information satisfies a set condition. For example, the processor 501 may determine whether the application executed in the electronic device 500 or the type of content provided through the application satisfies the set condition.

If the acquired state information does not satisfy the set condition, the processor may repeat operation 1609 to acquire the state information of the electronic device 500. For example, if the application executed in the electronic device 500 does not satisfy the set condition, the processor may continuously confirm the type of the application executed in the electronic device 500.

In operation 1613, if the acquired state information satisfies the set condition, the processor may determine whether a maintaining time set to the generated layer has elapsed. For example, if the acquired state information satisfies the set condition, as shown in operation 707 of FIG. 7, the electronic device may determine whether one minute has elapsed from a time point at which a layer set to be maintained for one minute is displayed on the touch screen.

If the maintaining time set to the generated layer has not elapsed, the processor may return to operation 1607 to display information generated based on the user input on the generated layer. For example, if the maintaining time set to the layer is one minute, the processor 501 may continuously display the information generated based on the user input on the generated layer until one minute elapses.

In operation 1615, if the maintaining time set to the generated layer has elapsed, the processor may delete the generated layer. For example, as shown in operation 709 of FIG. 7, if the maintaining time set to the generated layer is one minute, the processor 501 may delete the generated layer when one minute has elapsed from a time point at which the information generated based on the user input is displayed on the generated layer.

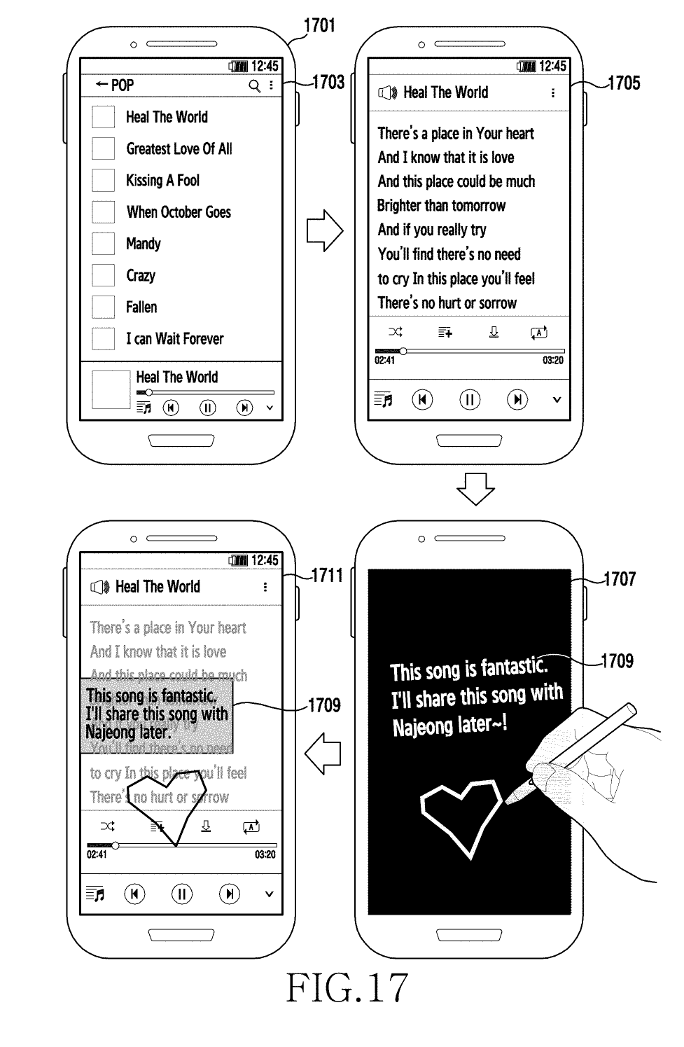

FIG. 17 illustrates an example of performing a memo function related to content based on a force input of an electronic device according to embodiments of the present disclosure.

Referring to FIG. 17, an electronic device 1701 may display a music list screen 1703 of a music application on a touch screen based on a user input. Upon selection of any one music application from the music list screen 1703 displayed on the touch screen, the electronic device 1701 may display a screen 1705 for providing information regarding the selected music while outputting the selected music. After the selected music is output, if the user input is not detected for a specific time duration, the electronic device 1701 may turn off the touch screen display. The electronic device 1705 may display on the touch screen a transparent layer 1709 including a memo generated based on the user input in response to the detection of a user's force input when the displaying of the touch screen is off.

For example, the electronic device 1701 may display on the touch screen 1707 the memo recorded through the user's force input on the transparent layer 1709, and the remaining regions of the touch screen may be maintained in an off state. Herein, a maintaining time may be set to the transparent layer 1709 based on a force caused by the user input on the touch screen. The electronic device 1701 may store the transparent layer 1709 by mapping the transparent layer 1709 to a music file reproduced when detecting the user's force input, and may display the transparent layer 1709 only when the music file is reproduced (or selected).

For example, if a music file to which the transparent layer 1709 is mapped is selected and thus information regarding the music is displayed on a screen (see 1711), the electronic device 1701 may display the mapped transparent layer 1709. In this case, the electronic device may change and display a graphic element of the transparent layer mapped to the music file. For example, the electronic device may change a stroke to be gradually decreased in size or to be gradually blurred from a time point of mapping the transparent layer 1709 to the music file. If the time set to the transparent layer 1709 elapses, the electronic device 1701 may delete the transparent layer 1709 mapped to the music file.

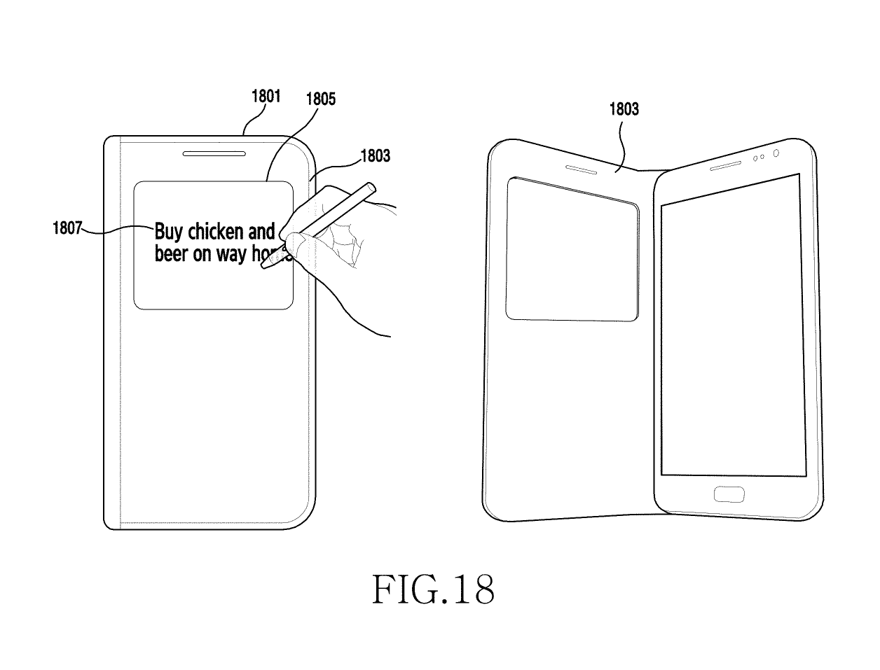

FIG. 18 illustrates an example of displaying information generated based on a force input in an electronic device according to embodiments of the present disclosure.

Referring to FIG. 18, if the displaying of a touch screen is off and a cover 1803 through which one region 1805 of the touch screen is exposed is closed, an electronic device 1801 may detect a user input through the exposed region 1805. If the detected user input is the force input, the electronic device 1801 may generate a layer 1807 including information generated based on the user input and may display the layer 1807 on the exposed region 1805.

The electronic device 1801 may determine whether to display the layer 1807 based on a state of the cover 1803. For example, if the cover 1803 is open, the electronic device 1801 may turn off the displaying of the layer 1807 displayed on the exposed region 1805. Alternatively, if the cover 1803 is open and thereafter is re-closed, the electronic device 1801 may re-display the layer 1807 on the exposed region 1805. The electronic device 1801 may determine whether to delete the layer 1807 based on a force caused by the user input. For example, the electronic device 1801 may set a maintaining time of the layer 1807 based on the force caused by the user input, and if the set maintaining time elapses, may delete the layer 1807. Alternatively, the electronic device 1801 may determine the number of times the cover 1801 is closed by using a magnitude of the force caused by the user input, and if the cover 1803 is closed by the determined number, may delete the layer 1807.

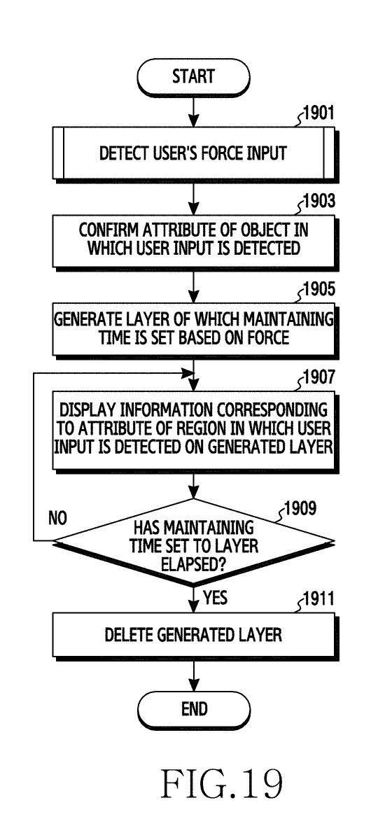

FIG. 19 illustrates a method of displaying notification information based on a force input in an electronic device according to embodiments of the present disclosure.

Referring to FIG. 19, a processor may detect a user's force input in operation 1901. For example, as shown in operation 701 of FIG. 7, the processor 501 may detect an input caused by the pen 600 through the pen touch sensor 541 when an application is running, or may detect a user input by receiving input information from the pen communication unit 603 of the pen 600 through the communication unit 530. The processor 501 may determine whether the user input is the force input based on a movement amount of the detected user input, a magnitude of a force, or whether the force is released. If the user input is the force input, the processor 501 may determine that the user's force input is detected.

In operation 1903, the processor may confirm a notification attribute of an object corresponding to the user's force input in response to the detection of the user's force input. For example, if a closed curve shaped force input is detected as the user input, the processor 501 may confirm an object included in the closed curve shaped user input. The processor 501 may confirm the notification attribute of the confirmed object. In examples, if the object included in the closed curve shaped user input is a watch, the processor 501 may confirm time related information. If the object included in the user input is a communication related icon, such as a Wi-Fi or Bluetooth icon of the electronic device, the processor 501 may confirm information related to a communication state of the electronic device.

In operation 1905, the processor may generate a layer of which a maintaining time is set based on a force caused by the user input in response to the confirmation of the notification attribute of the object corresponding to the user input. For example, the processor 501 may confirm a time corresponding to the force caused by the user input for the display 507 in response to the conformation of the attribute of the object in which the user input is detected. The processor 501 may generate a layer which is set to be maintained for the confirmed time. For example, the processor 501 may set the maintaining time of the layer such that the lower the force caused by the user input for the display 507, the less the maintaining time.

In operation 1907, the processor may display information corresponding to the attribute of the object in which the user input is detected on the layer generated in response to the generation of the layer of which the maintaining time is set based on the force caused by the user input. In examples, if the attribute of the object includes the time information, the processor 501 may display time information on the generated layer. If the attribute of the object includes the communication state (e.g., Wi-Fi information) of the communication unit 503, the processor 501 may display the communication state of the communication unit 530 on the generated layer.

In operation 1909, the processor may determine whether the maintaining time set to the layer has elapsed. For example, as shown in the operation 707 of FIG. 7, if the maintaining time of the generated layer is one minute, the processor 501 may determine whether one minute elapses from a time point of displaying information corresponding to an attribute of the object in which the user input is detected on the generated layer.

If the maintaining time set to the layer has not elapsed, the processor may return to operation 1907 to continuously display information corresponding to the attribute of the object in which the user input is detected on the generated layer. For example, if the maintaining time set to the layer is one minute, the processor 501 may continuously display the information corresponding to the attribute of the object in which the user input is detected in the generated layer on the display 507 until one minute elapses from a time point of displaying the information corresponding to the attribute of the object in which the user input is detected to the generated layer.

In operation 1911, if the maintaining time set to the generated layer has elapsed, the processor may delete the generated layer. For example, if the maintaining time set to the layer is one minute, the processor 501 may delete the generated layer when one minute elapses from the time point of displaying the information corresponding to the attribute of the object in which the user input is detected on the generated layer.

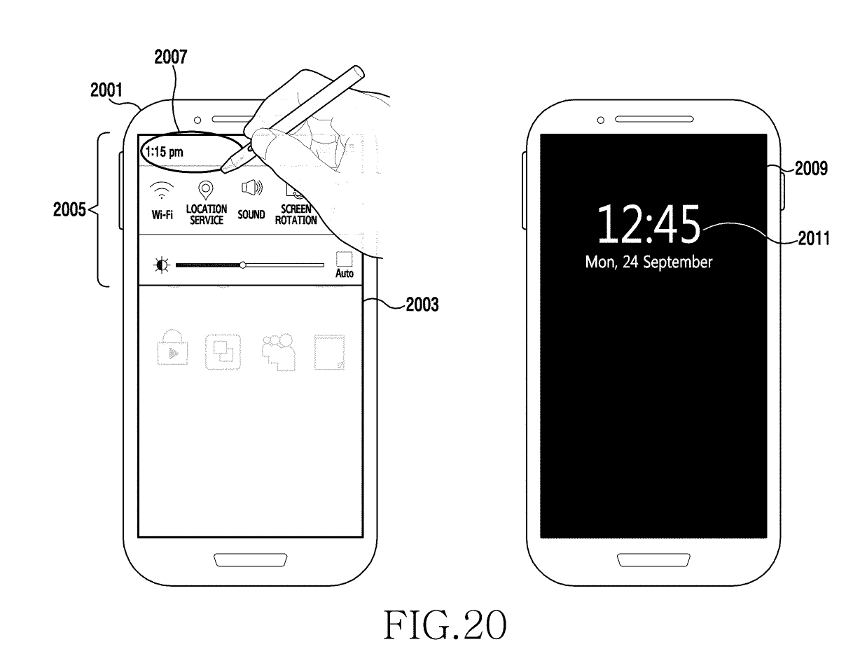

FIG. 20 illustrates an example of displaying notification information based on a force input in an electronic device according to embodiments of the present disclosure.

Referring to FIG. 20, an electronic device 2001 may detect an input caused by a stylus pen through a touch screen 2003, or may receive input information from the stylus pen. For example, the electronic device 2001 may detect an input 2007 caused by the stylus pen for a status bar 2005 displayed on one region of the touch screen 2003 through the touch screen 2003. Herein, the input 2007 caused by the stylus pen may include a closed curve shaped input.

The electronic device 2001 may confirm a notification attribute of an object included in the input 2007 of the closed curve shaped stylus pen in the status bar 2005 displayed on the touch screen 2003. In examples, if the closed curve shaped input 2007 includes a watch of the status bar 2005 displayed on the touch screen 2003, the electronic device 2001 may confirm time information. The electronic device 2001 may confirm Wi-Fi state information if the closed curve shaped input caused by the stylus pen includes a Wi-Fi icon of the status bar 2005 displayed on the touch screen 1603, and may display information corresponding to a notification attribute to one region of the touch screen based on the confirmed notification attribute when the touch screen is off.

In examples, if the touch screen is off (see 2009), the electronic device 2001 may generate a layer 2011 including time information and display the layer 2011 on the touch screen, or may generate a layer including Wi-Fi state information and display the Wi-Fi state information on the touch screen. The electronic device 2001 may determine a time of displaying the information corresponding to the notification attribute according to a force caused by the stylus pen as to the touch screen. The electronic device 2001 may determine an update cycle of the information corresponding to the notification attribute according to the force caused by the stylus pen as to the touch screen. In this case, the electronic device 2001 may determine the update cycle of the information corresponding to the notification attribute such that the greater the magnitude of the force, the shorter the update cycle.

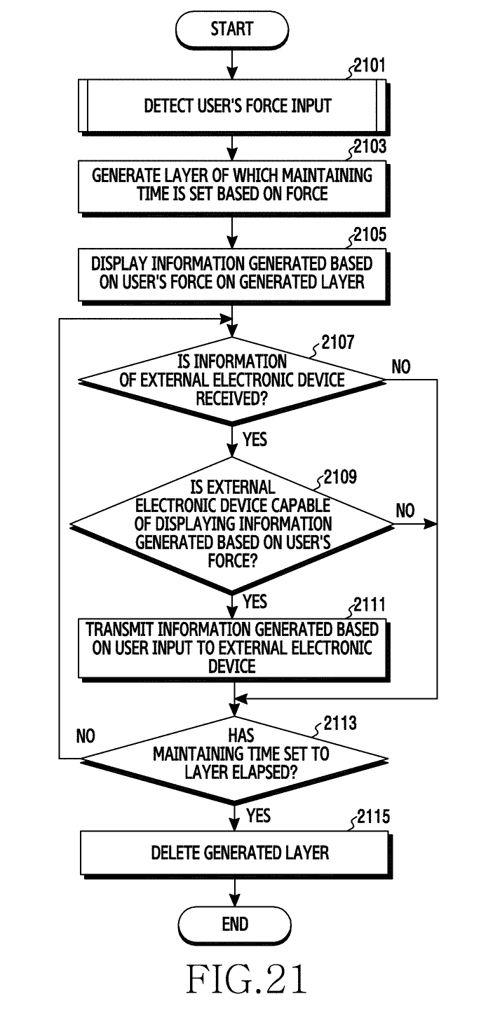

FIG. 21 illustrates a method of broadcasting information generated based on a force input in an electronic device according to embodiments of the present disclosure.

Referring to FIG. 21, in operation 2101, the processor may detect a user's force input. For example, similarly to operation 701 of FIG. 7, the processor 501 may detect the user input by receiving input information from the pen communication unit 603 of the pen 600 (e.g., the stylus pen) when displaying a main screen, or may detect the user input through the touch sensor 521 (or the pen touch sensor 541). If a movement amount of the detected user input is less than or equal to a first threshold, a force caused by the detected user input is greater than or equal to a second threshold, and the detected user input is moved instead of being released, then the processor 501 may determine the user input as the force input. If the user input is the force input, the processor 501 may determine that the force input is detected.

In operation 2103, the processor may generate a layer of which a maintaining time is set based on the force caused by the user input in response to the detection of the user's force input. For example, as shown in the operation 703 of FIG. 7, the processor 501 may generate a layer which is set to be maintained for a time corresponding to a magnitude of the force caused by the user input for the display 507 in response to the detection of the user's force input.

In operation 2105, the processor may display information generated based on the user's force on the generated layer. For example, as shown in the operation 705 of FIG. 7, the processor 501 may store a stroke generated based on the user input by loading a recognition engine from the memory 503, and may display the stroke on the generated layer.

In operation 2107, the processor may whether information of an external electronic device, such as a smart phone, a smart TV, a refrigerator, or a copy machine which is communicating with the electronic device is received. For example, the processor 501 may receive model information of the external electronic device to determine whether the external electronic device is capable of displaying information from the external electronic device which is communicating with the communication unit 530, information regarding whether the external electronic device is used by the user, or screen information such as information of contents reproduced in and of an application executed in the external electronic device.

If the information of the external electronic device is not received, the processor may proceed to operation 2113 and determine whether the maintaining time set to the layer has elapsed. For example, if the information of the external electronic device is not received from the external electronic device communicating with the communication unit 530, the processor 501 may determine that there is no external electronic device for transmitting the information generated based on the user input and thus may determine whether the maintaining time set to the layer has elapsed.

In operation 2109, upon reception of the information of the external electronic device, the processor may determine whether the external electronic device is capable of displaying the information generated based on the user input. For example, the processor 501 may confirm the information received from the external electronic device. If it is determined that the external electronic device is not being used by the user according to the information received from the external electronic device, the processor 501 may determine that the external electronic device is not capable of displaying the information generated based on the user input. Alternatively, if the external electronic device is executing specific content (e.g., movies) or specific applications (e.g., broadcasting applications) according to the information received from the external electronic device, the processor 501 may determine that the external electronic device is not capable of displaying the information generated based on the user input.

If the external electronic device is not capable of displaying the information generated based on the user input, the processor may perform the operation 2113 to confirm whether the maintaining time set to the layer has elapsed. For example, if the external electronic device is executing the broadcasting application, the processor 501 may determine that the external electronic device is not capable of displaying the information generated based on the user input and thus may determine whether the maintaining time set to the layer has elapsed.

According to embodiments of the present disclosure, in operation 2111, if the external electronic device is capable of displaying the information generated based on the user input, the processor may transmit the generated layer to the external electronic device. For example, if it is determined that the external electronic device includes the display by using the model information received from the external electronic device, the processor 501 may transmit the generated layer. For another example, if the external electronic device is not reproducing a movie, the processor 501 may transmit the generated layer.

In operation 2113, the processor may determine whether the maintaining time set to the layer has elapsed. For example, as shown in the operation 707 of FIG. 7, the processor 501 may determine whether one minute has elapsed from a time point at which the information generated based on the user input is displayed on a layer which is generated to be maintained for one minute.

If it is determined in operation 2113 that the maintaining time set to the layer has not elapsed, the processor may return to operation 2105 to continuously display the information generated based on the user input on the generated layer. For example, if one minute has not elapsed from a time point at which the information generated based on the user input is displayed on a layer which is set to be maintained for one minute, the electronic device may continuously display the information generated based on the user input.

In operation 2115, if the maintaining time set to the generated layer has elapsed, the processor may delete the generated layer. For example, as shown in the operation 709 of FIG. 7, if the maintaining time has elapsed from the time point at which the information generated based on the user input is displayed on the generated layer, the processor 501 may delete the generated layer.

Although it is described above that the processor receives information of the external electronic device communicating with the electronic device, according to embodiments of the present disclosure, the processor may select some electronic devices among the external electronic devices communicating with the electronic device, and may receive only information of the selected electronic device. In examples, the processor 501 may select some external electronic devices based on a force caused by the user input among a plurality of external electronic devices located at different distances and communicating with the communication unit 530 of the electronic device 500, and may receive information of the selected external electronic device. The processor 501 may select the external electronic device such that the greater the magnitude of the force caused by the user input for the display 507, the greater the distance of the external electronic device to be selected. In this case, the processor 501 may determine a distance to the external electronic device through signal strength caused by a stylus pen while a telephone application of the external electronic device communicating with the communication unit 530 is executed.

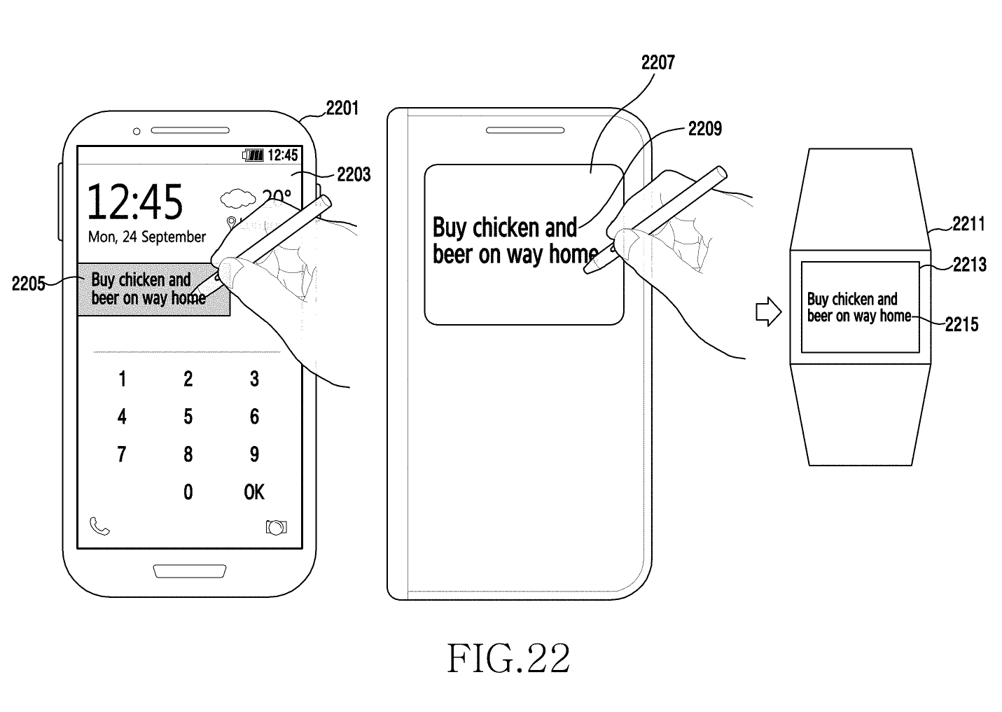

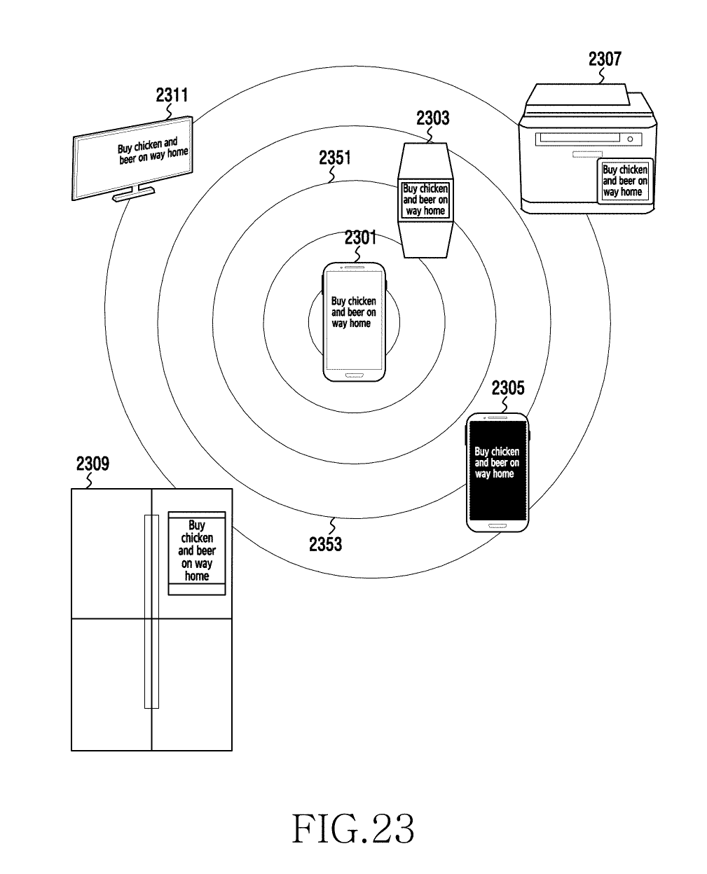

FIG. 22 illustrates an example of broadcasting information generated based on a force input in an electronic device according to embodiments of the present disclosure. FIG. 23 illustrates a range of broadcasting information generated based on a force input in an electronic device according to embodiments of the present disclosure.

Referring to FIG. 22, upon detection of a force input caused by a stylus pen while a telephone application is executed, an electronic device 2201 may generate a layer 2205 including a stroke generated based on an input caused by the stylus pen, and may display the generated layer 2205 on a layer 2203 of the telephone application. Alternatively, upon detection of the force input caused by the stylus pen when the displaying of the touch screen of the electronic device 2201 is off (see 2207), the electronic device 2201 may generate a layer 2209 including a stroke generated based on an input caused by the stylus pen, and may display the generated layer 2209 on one region of the touch screen, and thereafter, may confirm an external electronic device connected to a wireless communication circuit of the electronic device.

For example, as shown in FIG. 23, the electronic device 2201 may confirm a smart watch 2303, smart phone 2305, copy machine 2307, refrigerator 2309, and smart TV 2311 connected to the wireless communication circuit. The electronic device 2201 may select at least one electronic device among the conformed external electronic devices based on the force caused by the input of the stylus pen as to the touch screen. For example, if a magnitude of the force caused by the input of the stylus pen as to the touch screen is of a first level, the electronic device 2201 may select the smart watch 2303 located at a first search radius 2351. If the magnitude of the force caused by the input of the stylus pen as to the touch screen is of a second level, the electronic device 2201 may select at least one of the smart watch 2303 and smart phone 2305 included in a second search radius 2353. Herein, the first level may have a smaller value than the second level.

The electronic device 2201 may request and receive information of the selected external electronic device, and may transmit the layer 2205 or 2209 generated based on the received information to the selected external electronic device. For example, the electronic device 2201 may request the selected external electronic device to transmit information for confirming a display state of a screen of the selected external electronic device and thus may receive the information. The electronic device 2201 may determine a device capable of displaying the layer 2205 or 2209 generated through the information received from the selected external electronic device. For example, the electronic device 2201 may confirm whether the external electronic device is manipulated by a user through the information received from the selected external electronic device. If the selected external electronic device is manipulated by the user, the electronic device 2201 may be determined as the device capable of displaying the generated layer 2205.

Alternatively, the electronic device 2201 may determine whether the external electronic device selected by using the information received from the selected external electronic device has a screen for outputting the information. If the selected external electronic device has the screen for outputting the information, the electronic device 2201 may be determined as the device capable of displaying the generated layer 2205 or 2209.

In another example, the electronic device 2201 may determine whether the external electronic device selected by using the information received from the selected external electronic device is executing a broadcasting application. If the selected external electronic device is not executing the broadcasting application, the electronic device 2201 may be determined as the device capable of displaying the generated layer 2205 or 2209. The electronic device 2201 may transmit the generated layer 2205 or 2209 to an external electronic device 2211 determined through a wireless communication circuit. In this case, the external electronic device 2211 may display the layer 2205 received from the electronic device 2201 on a screen 2213. For example, upon receiving the layer 2205 from the electronic device 2201, the external electronic device 2211 may change a graphic element displayed on the layer 2205 by considering a usage environment of the external electronic device 2211, and may display a layer 2215 of which a graphic element is changed on the screen 2213 of the external electronic device.

The following are aspects according to embodiments of the present disclosure, as described above.

A method of operating an electronic device may include displaying a screen including at least one object on a touch screen display of the electronic device, receiving data indicating that the external object is pressed on the touch screen display by a force greater than or equal to a selected force from at least one of a force sensor of the electronic device and a wireless communication circuit of the electronic device, receiving a manual input through the touch screen display after the data is received, displaying at least one of an image and a character on the touch screen display in a manner overlapping with the screen based on the manual input, and deleting the at least one of the image and the character while directly maintaining the screen when a selected time elapses.

The external object may include a stylus pen.

A display of the touch screen may include a touch panel. The electronic device may further include a panel separated from the touch panel and configured to detect an input caused by the stylus pen.

The displaying of the at least one of the image and the character on the touch screen display in a manner overlapping with the screen based on the manual input may include displaying a first layer including the at least one object on the screen, and generating a second layer on which the at least one of the image and the character are displayed so that the second layer is displayed on the screen in a manner overlapping with the first layer.

The second layer may have at least one different location and size for displaying the second layer based on an input caused by the stylus pen.

The method may further include storing the image and/or the objet into a memory of the electronic device.

According to embodiments, the screen may include a home screen, and the object may include at least one icon for displaying an application program.

The screen may include a user interface screen of an application program, and the object may include at least one button for selecting a function.

The application program may include a telephone application program.

The method may further include transmitting the at least one of the image and the character to an external electronic device connected to the wireless communication circuit.

The method may further include determining an update cycle for the at least one of the image and the character based on the data, and updating the at least one of the image and the character according to the determined cycle.

A method of operating an electronic device may include displaying a screen including at least one object on a touch screen display of the electronic device, receiving data indicating that the external object is pressed on the touch screen display by a force greater than or equal to a selected force from an external object through a wireless communication circuit of the electronic device, receiving a manual input through the touch screen display after the data is received, displaying at least one of an image and a character on the touch screen display in a manner overlapping with the screen based on the manual input, and deleting the at least one of the image and the character while directly maintaining the screen when a selected time elapses.

A method of operating an electronic device may include receiving data indicating that the external object is pressed on the touch screen display by a force greater than or equal to a selected force from at least one of a force sensor of the electronic device and a wireless communication circuit of the electronic device when a first panel of a touch screen display of the electronic device is off, receiving a manual input through a second panel of the touch screen display after the data is received, displaying at least one of an image and a character based on the manual input by using the first panel, and no longer displaying the at least one of the image and the character on the first panel when a selected time elapses.

A method of operating an electronic device may include receiving data indicating that the external object is pressed on the touch screen display by a force greater than or equal to a selected force from a wireless communication circuit of the electronic device when a first panel of a touch screen display of the electronic device is off, displaying at least one of an image and a character based on the manual input by using the first panel, and no longer displaying at least one of the image and the character on the first panel when a selected time elapses.

In a method and apparatus for operating an electronic device according to embodiments, information generated based on a user's force input is displayed for a specific time duration depending on a force, and thus a user can more easily control the electronic device.

The term “module” used in the present disclosure includes a unit consisting of hardware, software, or firmware, and may be interchangeably used with a term such as a unit, a logic, a logical block, a component, a circuit, and the like. A “module” may be an integrally constructed component or a minimum unit or one part thereof for performing one or more functions. A “module” may be mechanically or electrically implemented, and may include an application-specific integrated circuit (ASIC) chip, field-programmable gate arrays (FPGAs), or a programmable-logic device, which is known or to be developed in the future. At least one part of an apparatus (e.g., modules or functions thereof) or method according to embodiments may be implemented with an instruction stored in a computer-readable storage media. If the instruction is executed by one or more processors, the one or more processors may perform a function corresponding to the instruction. For example, the computer-readable storage media may include a hard disk, a floppy disk, magnetic media (e.g., a magnetic tape), optical media (e.g., a compact disc-ROM (CD-ROM), a digital versatile disc (DVD), magnetic-optic media (e.g., a floptical disk)), or an internal memory. The instruction may include a code created by a compiler or a code executable by an interpreter. The module or programming module according to embodiments may further include at least one or more constituent elements among the aforementioned constituent elements, or may omit some of them, or may further include additional other constituent elements. Operations performed by a module, programming module, or other constituent elements may be executed in a sequential, parallel, repetitive, or heuristic manner. In addition, some of the operations may be executed in a different order or may be omitted, or other operations may be added.

Embodiments included in the present disclosure are provided for explaining and understanding technical features, not for limiting the scope of the present disclosure. Therefore, all changes based on the technical features of the present disclosure or various other embodiments will be construed as being included in the scope of the present disclosure.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. An electronic device comprising:
a housing including a first surface directed in a first direction and a second surface directed in a second direction opposite to the first direction;
a touch screen display located between the first surface and the second surface and exposed through the first surface;
a force sensor located between the first surface and the second surface and detecting a force caused by an external object as to the touch screen display;
a wireless communication circuit;
at least one processor electrically connected to the touch screen display, the force sensor, and the wireless communication circuit; and
a memory electrically connected to the processor,
wherein the memory comprises instructions, when executed, cause the processor to:
display a screen including at least one object on the touch screen display;
receive data indicating that the external object is pressed on the touch screen display by a force greater than or equal to a selected force from at least one of the force sensor and the wireless communication circuit;
receive a manual input through the touch screen display after the data is received;
display at least one of an image and a character on the touch screen display in a manner overlapping with the screen, based on the manual input; and
delete the at least one of the image and the character while directly maintaining the screen when a selected time has elapsed.

2. The apparatus of claim 1, wherein the external object comprises a stylus pen.

3. The apparatus of claim 2,
wherein the display of the touch screen comprises a touch panel, and
wherein the electronic device further comprises a panel separated from the touch panel and configured to detect an input caused by the stylus pen.

4. The apparatus of claim 3, wherein the instructions cause the at least one processor to display a first layer comprising the at least one object on the screen and generate a second layer on which the at least one of the image and the character are displayed so that the second layer is displayed on the screen in a manner overlapping with the first layer.

5. The apparatus of claim 4, wherein the second layer has at least one of a different location and a different size for displaying the second layer based on an input caused by the stylus pen.

6. The apparatus of claim 1, wherein the instructions cause the at least one processor to store the at least one of the image and the object into the memory.

7. The apparatus of claim 1,
wherein the screen comprises a home screen, and
wherein the object comprises at least one icon for displaying an application program.

8. The apparatus of claim 1,
wherein the screen comprises a user interface screen of an application program, and
wherein the object comprises at least one button for selecting a function.

9. The apparatus of claim 1, wherein the instructions cause the at least one processor to transmit the at least one of the image and the character to an external electronic device connected to the wireless communication circuit.

10. The apparatus of claim 1, wherein the instructions cause the at least one processor to determine an update cycle for the at least one of the image and the character based on the data and to update the at least one of the image and the character according to the determined cycle.

11. An electronic device comprising:
a housing including a first surface directed in a first direction and a second surface directed in a second direction opposite to the first direction;
a touch screen display located between the first surface and the second surface and exposed through the first surface;
a wireless communication circuit;
at least one processor electrically connected to the touch screen display and the wireless communication circuit; and
a memory electrically connected to the at least one processor,
wherein the memory comprises instructions which, when executed, cause the processor to:
display a screen comprising at least one object on the touch screen display;
receive data indicating that the external object is pressed on the touch screen display by a force greater than or equal to a selected force from an external object through the wireless communication circuit;
receive a manual input through the touch screen display after the data is received;
display at least one of an image and a character on the touch screen display in a manner overlapping with the screen based on the manual input; and
delete the at least one of the image and the character while directly maintaining the screen when a selected time has elapsed.

12. A method of operating an electronic device, the method comprising:
displaying a screen including at least one object on a touch screen display of the electronic device;
receiving data indicating that the external object is pressed on the touch screen display by a force greater than or equal to a selected force from at least one of a force sensor of the electronic device and a wireless communication circuit of the electronic device;
receiving a manual input through the touch screen display after the data is received;
displaying at least one of an image and a character on the touch screen display in a manner overlapping with the screen based on the manual input; and
deleting the at least one of the image and the character while directly maintaining the screen when a selected time has elapsed.

13. The method of claim 12, wherein the external object comprises a stylus pen.

14. The method of claim 13,
wherein the display of the touch screen comprises a touch panel, and
wherein the electronic device further comprises a panel separated from the touch panel and configured to detect an input caused by the stylus pen.

15. The method of claim 14, wherein the displaying of the at least one of the image and the character on the touch screen display in a manner overlapping with the screen based on the manual input comprises:
displaying a first layer comprising the at least one object on the screen; and
generating a second layer on which the at least one of the image and the character are displayed so that the second layer is displayed on the screen in a manner overlapping with the first layer.

16. The method of claim 14, wherein the second layer has at least one of a different location and a different size for displaying the second layer based on an input caused by the stylus pen.

17. The method of claim 12, further comprising storing the at least one of the image and the objet into a memory of the electronic device.

18. The method of claim 12,
wherein the screen comprises a home screen, and
wherein the object comprises at least one icon for displaying an application program.

19. The method of claim 12,
wherein the screen comprises a user interface screen of an application program, and
wherein the object comprises at least one button for selecting a function.

20. The method of claim 12, further comprising transmitting the at least one of the image and the character to an external electronic device connected to the wireless communication circuit.
